(19) United States
(12) Patent Application Publication
(10) Pub. No.: US 2013/0014084 A1
(43) Pub. Date: Jan. 10, 2013

(54) International Testing Platform

(75) Inventors: Ali R. Sahibzada, Bellevue, WA (US); Michael J. Eatherly, Puyallup, WA (US)

(73) Assignee: Microsoft Corporation, Redmond, WA (US)

(21) Appl. No.: 13/176,729

(22) Filed: Jul. 5, 2011

(51) Int. Cl. G06F 9/44

(52) U.S. Cl. 717/124; 717/122

(57) ABSTRACT

An International Testing Platform (ITP) provides a comprehensive, cohesive environment for managing testing and review validation activities for product versions scheduled to be released to market. An ITP allows each user to be part of a community of users whose work product is shared to generate a robust product test and review experience. An ITP also automates various testing and product review activities to increase verification throughput and reduce validation time and cost.

### BACKGROUND

With the global nature of today's economy international customers are important and it is incumbent on a company to strive to be first to market with its product and to ship its article of merchandise in all, or at least a significant variety, of the languages of the company's international customers expeditiously when the sales article is released for consumption. To this end, to remain competitive and efficaciously reach various global markets many companies strive to produce their products, e.g., software, in a wider set of languages than just one, e.g., English, and to ship the resultant sales merchandise effectively simultaneously in all their supported languages.

However, localization and manual validation of a product in all the languages of its sales release can represent a significant production and sales bottleneck, both in time to market and cost perspectives. Manual validation of product localization, i.e., manual validation of the correctness of the language of a product, e.g., software, is often time consuming, labor intensive and costly. For example, to validate the correct localization of a software product's features, e.g., the software's user interface (UI) text strings, the software may need to be manually installed on a computing device, e.g., a computer, laptop, cell phone, etc., collectively referred to herein as a computing device. The software under test may be required to be executed many times to allow an operator, also referred to herein as a tester, or, more generally, a user, to validate its product localization, or, alternatively, identify issues and/or errors. The tester may have to manually report identified localization issues, including, but not limited to, truncation, clipping, overlapping, non-localized text, etc., for subsequent error correction and revalidation efforts.

Moreover, to validate the behavior of a specific product localization feature, e.g., a specific UI screen or string of a software product, across all the product's release languages increases the localization validation complexity and cost, including, but not limited to, often entailing timely uninstall and reinstall procedures to test alternative product release language versions.

And while automated screenshot capturing can assist in alleviating some product localization validation complexity, even if automated product screenshots can be provided to the

The manual identification of product aspects, e.g., software screenshots, strings, new features, market content, images, date/time information and formatting, etc., also referred to herein as product entities, for verifying specific product problems, the subsequent manual reporting of identified product issues, and the manual maintenance of information on tested product entities in various product release languages including the respective product localization validation test cases is generally not scalable, and thus not an effective solution for localization validation of products that support multiple languages and/or multiple environments. For example, when an issue on a specific product language version and/or build is discovered it currently can be a significant time investment to determine when the issue was introduced into the product by reviewing previous product builds; whether the issue is also resident in other product language versions of the same product build; whether the issue exists in different product language versions of one or more prior product builds; whether the issue exists in other product version environments; etc.

To add to the complexity of the localization validation process each testing team, often situated in various global locations, can utilize different share locations, security settings, processes, tools for managing the validation processes, etc., effectively constituting a group of asynchronous testing sites. This can lead to, among other things, costly duplication of testing efforts, wasteful lost use of already known relevant product and testing information, steep time and monetary expenses for the management of duplicate information, etc.

Thus, it is desirable to mitigate the time, complexity, efforts and cost associated with validating various product versions for consumer release. Moreover, it is desirable to minimize, and eliminate to the extent possible, company inefficiencies engendered by overlapping validation efforts. Too, it is desirable to reduce a product's time to market, automate various product validation process aspects and increase product validation throughput.

### SUMMARY

This summary is provided to introduce a selection of concepts in a simplified form which are further described below in the Detailed Description. This summary is not intended to identify key or essential features of the claimed subject matter, nor is it intended to be used as an aid in determining the scope of the claimed subject matter.

Embodiments discussed herein include systems and methodology for product version testing that allows users to generate and share product and product testing information.

In embodiments an international test platform is a product test management system with functionality that, among other tasks, supports the execution of test cases on a product version, the capture of software version output components generated as a result of test case execution, user and automatic review of software version output components for verification, product test progress, bug report generation, and efficient sharing of product and product testing information. In embodiments an international test platform incorporates testing tools and test and product database information into a single cohesive test, product review and product information environment.

In embodiments a methodology for supporting centralized comprehensive product version validation to verify correct language usage in product version output screens includes functionality for enabling the execution of test cases for product versions, storing product version screens generated by the execution of test cases on a product version, and outputting various review views to a user comprising differing combinations of product version screens. In embodiments methodology for supporting centralized comprehensive product version validation further includes supporting user product version screen review and error identification and reporting. In embodiments methodology for supporting centralized comprehensive product version validation includes the collection and sharing of product and product testing information and automatic generation of test information and statistics, e.g., automatic generation of bug report information, product version testing progress, product version error statistics, etc. In embodiments methodology for supporting centralized comprehensive product version validation incorporates the utilization of test tools and test and product database information in a single cohesive environment.

### BRIEF DESCRIPTION OF THE DRAWINGS

These and other features will now be described with reference to the drawings of certain embodiments and examples which are intended to illustrate and not to limit, and in which:

FIG. 1 depicts an embodiment international testing platform, also referred to herein as an ITP, within an embodiment ITP environment wherein the ITP is in cooperation with various product elements, testing elements and other entities.

FIG. 2 depicts an embodiment ITP.

FIG. 3 depicts an exemplary embodiment ITP test initiation screen.

FIG. 4 depicts an exemplary embodiment ITP review initiation screen.

FIG. 5 depicts an exemplary ITP screen that is a pivot view of a product version's screens.

FIG. 6 depicts an exemplary product version screen with identified errors thereon.

FIG. 7 depicts an exemplary ITP screen containing the same product screenshot for various product versions, i.e., a cross-language view.

FIG. 8 depicts an exemplary ITP bug report template screen.

FIGS. 9A-9E depicts an embodiment logic flow for an ITP methodology supporting product management, testing and review.

FIG. 10 is a block diagram of an exemplary basic computing device with the capability to process software, i.e., program code, or instructions.

### DETAILED DESCRIPTION

In the following description, for purposes of explanation, numerous specific details are set forth in order to provide a thorough understanding of embodiments described herein. It will be apparent however to one skilled in the art that the embodiments may be practiced without these specific details. In other instances well-known structures and devices are either simply referenced or shown in block diagram form in order to avoid unnecessary obscuration. Any and all titles used throughout are for ease of explanation only and are not for any limiting use.

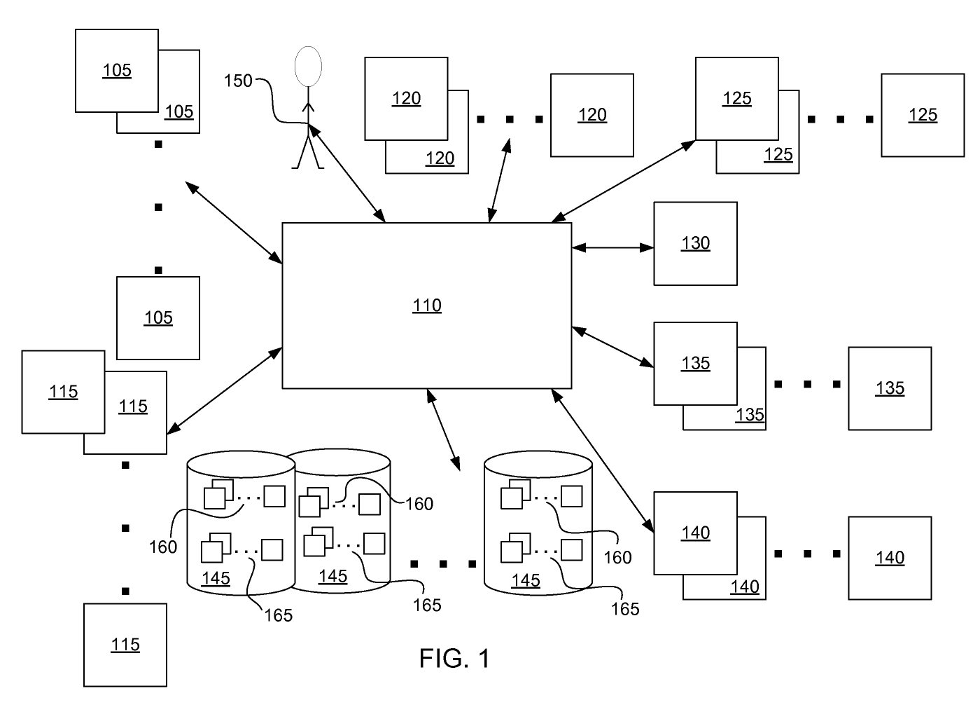

Referring to FIG. 1, an embodiment international testing platform, also referred to herein as an ITP, 110 is depicted in cooperation with various product elements, testing elements and other entities. In an embodiment the ITP 110 supports the testing and review of software products. In an embodiment the ITP 110 supports the testing and review of software products that have various language versions, e.g., an English version, a Spanish version, a French version, etc. For purposes of discussion herein the embodiment ITP 110 is utilized with software products with at least two different language versions, although this discussion is not intended to be a limitation of a general ITP or any specific ITP.

In an embodiment the ITP 110 has access to various product versions 115. In embodiments differing product versions 115 can consist of different builds, e.g., different software capabilities and/or code for enabling one or more supported software capabilities; alternative languages, e.g., English, Spanish, French, etc.; targeted for different environments; etc.

In an embodiment the ITP 110 has access to product screens, also referred to herein as product screenshots, screens, screenshots, or graphical U/Is, i.e., user-interface, 135 of one or more product versions 115. In embodiments the product screenshots 135 can be used by the ITP 110 to display to a tester, also referred to herein more generally as a user, 150, perform manual and/or automatic analysis upon, generate statistics for, generate or assist in the generation of bug reports 160 for, create updates for, etc.

In an embodiment the ITP 110 has access to one or more U/I software files, or documents, 105 that each contain an identification of one or more graphical U/Is 135, or a subset of the components and/or layout of one or more graphical U/Is 135, for a software product version 115. In an aspect of this embodiment each U/I software file 105 contains a text description of one or more graphical U/Is 135, or a subset of the components and/or layout of one or more graphical U/Is 135, for a software product version 115. In an aspect of this embodiment a U/I software file 105 can also, or alternatively, contain information on one or more graphical U/Is 135, or a subset of the components and/or layout of one or more graphical U/Is 135, and/or the relationship(s) between a graphical U/I 135 and other graphical U/Is 135, product elements, testing elements, ITP components, etc. and/or the relationship(s) between a component or layout of one or more graphical U/Is 135 and other graphical U/Is 135, graphical U/I components, graphical U/I layouts, product elements, testing elements, ITP components, etc.

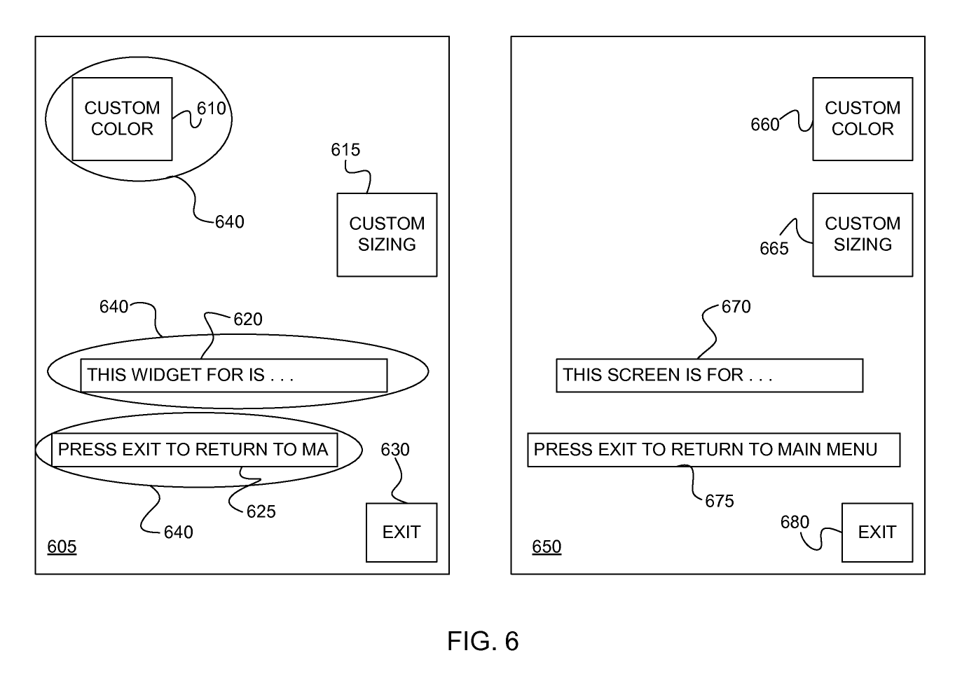

For example, one U/I software file 105 may describe the components, e.g., fields, buttons, static text, editable text fields, check boxes, text boxes, icons, scrollbars, menus, etc., and layout, e.g., component positioning, component colors, background screen colors, component size, etc., of one screen 135 that is output by a product version 115 to a product consumer, i.e., a user of the product. In this example, one U/I software file 105 may describe the components and layout for the graphical U/I 605 of FIG. 6 that can be output to a product consumer by a particular product version 115.

As another example, one U/I software file 105 may describe a subset of one or more screen components and their layout for one product screen 135 output by a product version 115. In this second example one U/I software file 105 may describe the components 610, 615 and 630 and their layout for the exemplary graphical U/I 605 of FIG. 6 that can be output by a particular product version 115.

As a third example, one U/I software file 105 may describe the components and layout of all the graphical U/Is 135 output by a product version 115.

For a fourth example, one U/I software file 105 may include various relevant associations and/or relationships for a graphical U/I 135 and/or a subset of the components and/or layout of the graphical U/I 135. Exemplary described associations and relationships include, but are not limited to, the respective product version owner, e.g., code designer or group, the location where errors for the graphical U/I 135 or a subset of its components and/or layout are to be reported, the location of testing data for the graphical U/I 135 or a subset of its components and/or layout, the location of test cases for the graphical U/I 135 or a subset of its components and/or layout, the relationship of the graphical U/I 135 to other product version graphical U/Is 135, e.g., child, etc., etc.

In an embodiment the ITP 110 may have access to one or more design files, or documents, 120 that each contain an identification of what one or more graphical U/Is 135, or subsets of one or more graphical U/Is 135, for a software product version 115 are intended to look like. In an embodiment a design file 120 describes, in words, via static text, commands, etc., and/or graphics, what one or more product screens 135, or a subset of one or more product screens 135, of a software product version 115 are intended to look like.

In an embodiment the ITP 110 can use one or more design files 120 and/or an analysis thereof and one or more U/I software files 105 and/or an analysis thereof to determine if a product screen 135 for a target end product version 115 is coded as designed, and if not, attempt to identify what the discrepancy between intent and reality may be.

In an embodiment the ITP 110 may have access to a set of one or more test cases 125 that have been generated to test a software product version 115, or versions 115, for, e.g., correct functioning, proper locality, i.e., proper use of the native language in the software product version 115, etc. In an aspect of this embodiment a test case 125 can run, i.e., execute, a software product version 115. In an aspect of this embodiment a test case 125 can capture, i.e., snapshot, one or more screens 135 output by a software product version 115. Captured screens 135 and related meta data can thereafter be reviewed by a user 150. Also, or alternatively, an embodiment ITP 110 can automatically analyze captured screens 135 and related meta data to determine and/or aid in the determination of their correctness.

In an embodiment the ITP 110 may have access to a tool set 130 of one or more test, or test support, tools. Test tools can include, but are not limited to, a SAT (string analysis tool), a WTT (Windows Test Technologies test suite), a MAT (market analysis tool) designed to analyze marketized product version content, a code analysis tool, an auto truncation detector tool, etc.

In an embodiment the ITP 110 utilizes output from one or more of the test set tools 130 to provide test information and test analysis information to a user 150. In an embodiment the ITP 110 utilizes output from one or more test set tools 130 to formulate a suggestion for what a discovered graphical U/I error is, e.g., text improperly clipped, text not properly localized, i.e., not properly translated into the target language for the product version 115, text improperly located on the screen, etc.

In an embodiment the ITP 110 uses output from one or more test set tools 130 to formulate a suggestion for a correction for an identified product screen error. In embodiments the ITP 110 uses output from one or more test set tools 130 to perform, or assist in the performance of, a variety of other functions such as, but not limited to, automatically generate a bug report 160 for a discovered graphical U/I error; help a user 150 generate a bug report 160 for a discovered graphical U/I error; generate test statistics 165 for a product version 115, all product versions 115 in a specific language, e.g., Spanish, all product versions 115 established for a specific environment, product versions 115 for one or more identified builds, etc.; etc.

In an embodiment the ITP 110 generates and maintains statistics and information on the test set tools 130, e.g., the last time a particular test set tool 130 was used, the last product version 115 a particular test set tool 130 was used on, when a test set tool 130 was last updated, the identity of the person(s) who last updated a specific test set tool 130, etc.

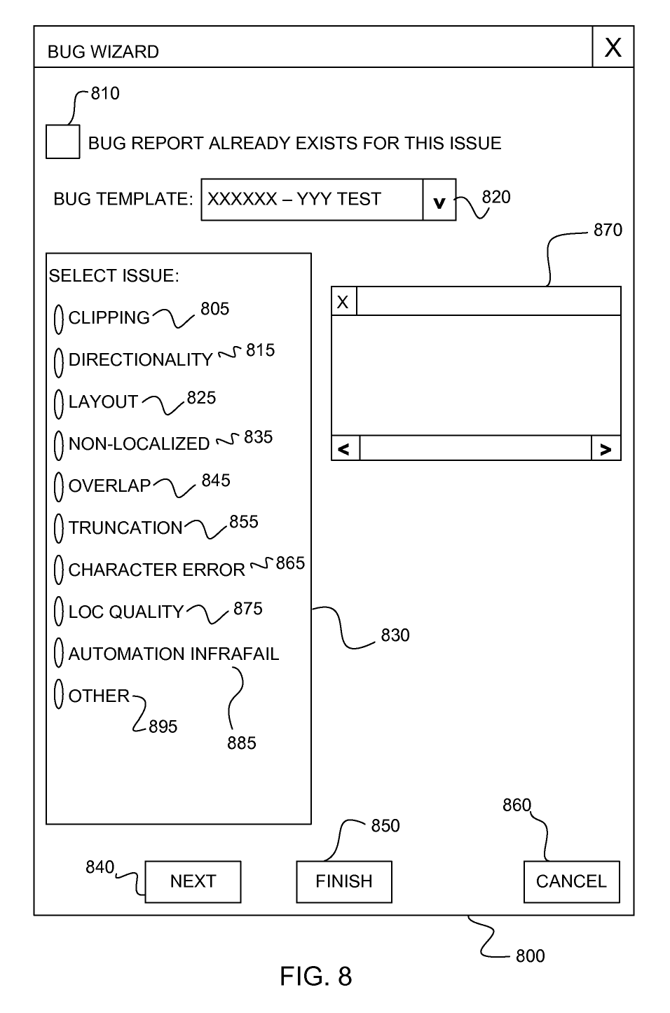

In an embodiment the ITP 110 has ITP-generated screens 140 that are output to a user 150. Embodiment ITP screens 140 can include screens that display information, analysis and/or test statistics 165 to a user 150; ITP screens 140 that display product screenshots 135 to a user 150; ITP screens 140 that allow a user 150 to interact and/or command the ITP 110, for example, the bug report screen 800 of FIG. 8, further discussed below; ITP screens 140 that allow a user 150 to test a product version 115 via the ITP 110; etc.

In an embodiment the ITP 110 has or has access to one or more ITP databases 145 that are used to store a variety of information related to, or otherwise relevant to, one or more products and/or testing and/or review efforts. ITP databases 145 can contain information including, but not limited to, product details, e.g., product version languages, etc., product version details, user security for a product and/or product versions 115, test identification, test data, test analysis, test statistics 115 and results, tester identification, reviewer identification, product administrative entity identification, product errors, also referred to herein as bugs, bug reports 160, bug fixes, product version information, product version screenshots 135, meta data for, or otherwise related to, product version screenshots 135, pointers to relevant information, etc.

As previously discussed, a user 150 can interact with the ITP 110 to render efficiencies in the product testing and review process by, e.g., the elimination of previously performed manual testing/review efforts. This includes, inter alia, the ITP 110 automatically gathering relevant product and product test and/or review information from various sources and outputting it to a user 150 through a single environment, i.e., the ITP 110; the ITP 110 automatically populating relevant sets of information related to a product and its testing and/or review; the ITP 110 collating product and product test, review, error identification and error correction information across various groups and localities for the creation and maintenance of a single cohesive product testing/review arena, or platform; etc.

In an embodiment an ITP 110 is a multi-tiered system and methodology that enables, e.g., increased automated testing; comprehensive and efficient product review within one environment; a cohesive testing environment across product versions 115; a variety of user-selective product version screen review views; efficient processing and analysis of product versions 115 for verifying product version 115 accuracy and performance; etc.

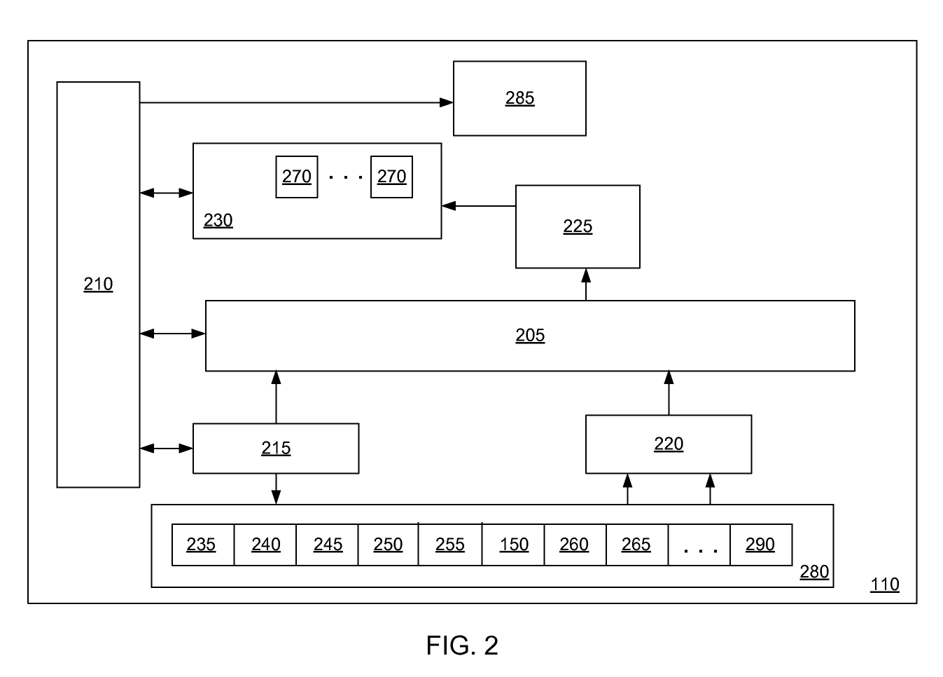

Referring to FIG. 2, an embodiment ITP 110 includes a manager 210 component. In an embodiment the manager 210 controls and manages the flow of data into the ITP 110. In an embodiment the manager 210 has a front-end U/I for receiving input from other software components and users 150, e.g., test cases from an automated test case manager and/or users 150; test commands, bug report information, etc., from users 150; new product versions from an automated product manager and/or users 150; test results from test software outside the ITP 110; review commands from users 150; user input identifying errors on a product version screenshot 135; user input identifying a product version screenshot has passed, or alternatively, failed, review; etc.

In an embodiment the manager 210 communicates with other ITP components, i.e., the reporter 230, the analyzer 205 and the scheduler 215, manages the flow of data between these ITP components, and triggers the proper ITP component and/or processing layer to receive or deliver information at the appropriate time. For example, the manager 210 takes information generated for a localization test pass and creates a schedule to trigger the main U/I 240 of the ITP 110 when a new build for a product version 115 becomes available for testing.

In an embodiment the manager 210 triggers the analyzer 205 to analyze new product versions 115 as they become available to the ITP 110.

In an embodiment the manager 210 triggers bug error reporting and test status activity reporting.

In an embodiment the manager 210 triggers a notification for one or more various detected events, such as, but not limited to, when a new product version 115, product version build, etc., is available for testing and/or review; when a predetermined threshold, e.g., fifty percent, of screens 135 for a product version 115 have identified bugs; when efforts on testing and/or review fall behind schedule; etc.

An embodiment ITP 110 includes a producer 280 component. In an embodiment the producer 280 generates consumable output, e.g., user review results, test results, test logs, product version(s) screenshots 135 that are generated and captured when a product version 115 is executed, results collections, e.g., aggregated test results and/or analysis thereof of two or more product versions 115, etc., etc., relevant to the ITP 110 supported product version 115 validation. In an embodiment the producer 280 generates consumable output in the form of ITP screens 140 for a user 150 to utilize to command the ITP 110 and review product version output, e.g., screenshots 135. Consumable output is output that can be presented to a user 150, or other individuals or entities, for information, commanding the ITP 110, review and analysis.

In an embodiment the producer 280 itself consists of various entities. In an embodiment users 150 are producers 280 when they issue commands via the ITP 110 that result in generated consumable output, e.g., when a user 150 performs manual or semi-manual testing on a product version 115, when a user 150 directs the capture of one or more product version screens 135, when a user 150 generates a bug report 160, etc.

In an embodiment the producer 280 has a producer U/I 240, also referred to herein as the main U/I 240, for the ITP 110 to input, or otherwise reference, product version screenshots 135 that have been generated external to the ITP 110. In an aspect of this embodiment the producer 280 can utilize the producer U/I 240 to automatically input or otherwise reference externally generated screenshots 135.

In an embodiment the producer 280 includes, or otherwise has access to, the test set tools 130, e.g., a SAT (string analysis tool) 235, a WTT (Windows Test Technologies test suite) 245, a MAT (market analysis tool) 250, a code analysis tool 255, etc. In embodiments the producer 280 includes, or otherwise has access to, a variety of additional or other test tools 290, including, but not limited to, an auto truncation detector tool, etc.

In an embodiment the producer 280 includes, or otherwise has access to, one or more software tools 260 designed to assist product version testing, information capture, testing review and analysis, referred to herein generically as testing assistance tools 260. Exemplary testing assistance tools 260 include, but are not limited to, screen shot capturing scripts for capturing a product version's screens 135, test case statistic generators which, e.g., keep track of which test cases are run at what times and by whom, how often a test case is run, which group of users 150 run which test cases and when, etc., etc.

In an embodiment producer managerial jobs 265 are another producer 280 entity and include tasks for generating and maintaining various depots in one or more ITP databases 145, i.e., collections of various related files, e.g., product version 115 source code depots, i.e., collections of various source code files for various product versions 115, product version design file 120 depots, etc. Producer managerial jobs 265 can also include, e.g., jobs, also referred to herein as tasks, for daily deploying new builds within the ITP 110 environment, tasks for managing product versions 115, etc.

An embodiment ITP 110 includes a scheduler 215 component. In an embodiment the scheduler 215 controls requests to the producer 280 in order to properly trigger a product management, testing or review related activity. For example, the scheduler 215 can trigger a producer 280 entity when a new product version 113 is available to the ITP 110. As another example, the scheduler 215 triggers a producer 280 entity when one or more test set tools are to be run on one or more product version(s) 115.

In an embodiment the scheduler 215 generates and issues notifications to a user 150 during various phases of ITP 110 general maintenance and specific testing and product version 115 review processes. In an embodiment the scheduler 215 can also generate and issue notifications to other relevant entities and/or individuals associated with the product versions 115 and/or the ITP 110, e.g., product version designers, product version coders, ITP 110 administrators, etc.

In an embodiment other ITP components can also, or alternatively, generate and issue notifications to a user 150 and/or other relevant entities and/or individuals associated with the product versions 115 and/or the ITP 110.

In an embodiment the scheduler 215 triggers the analyzer 205 to perform product version 115 related analysis as discussed below.

An embodiment ITP 110 includes a consumer 220 component. In an embodiment the consumer 220 stores data received, or gathered, from the producer 280 for usage, e.g., in product version 115 analysis, test information sharing, test results collection generation, etc. In an embodiment the consumer 220 takes data generated by the producer 280, stores the data in one or more ITP databases 145 and renders appropriate generated data available to the analyzer 205.

For example, in an embodiment the consumer 220 can take, or consume, manual input from a user 150 for storage in one or more ITP databases 145 and for subsequent usage by the analyzer 205 and/or users 150. As another example, in an embodiment the consumer 220 can consume produced test data from one or more test set tools, e.g., the SAT (string analysis tool) 235, the code analysis tool 255, an auto truncation detector tool 290, etc., for storage in one or more ITP databases 145 and for subsequent analyzer 205 and/or user 150 usage.

An embodiment ITP 110 includes an analyzer 205 component. In an embodiment the analyzer 205 performs analysis on test results, product versions 115, test cases, and other test related components. In an embodiment the analyzer 205, via the scheduler 215, and/or directly, triggers one or more test set tools 130 to perform specific automated analysis. For example, the analyzer 205, via the scheduler 215, and/or directly, triggers the SAT 235 to perform an automated analysis on the localized components, i.e., text components, of a product version 115, or versions 115.

In an embodiment, once the analyzer 205 completes all its analysis a user 150, or other individuals and/or entities, can know the internal anatomy of one or more product versions 115. In an aspect of this embodiment the analyzer 205 correlates various pieces of information from the producer 280, test cases 125, U/I software files 105, design files 120, product version(s) screenshots 135 and/or other relevant information stored in one or more ITP databases 145, e.g., bug reports 160, etc., to create an integrated, cohesive identification of one or more product versions 115 and the global product market environment.

An embodiment ITP 110 includes a bug handler 225 component. In an embodiment the bug handler 225 collates error report information into an appropriate form. In an embodiment the bug handler 225 can be invoked by a user 150 to generate a bug, or error, report on an aspect(s) of a product version(s) 115. In an embodiment the bug handler 225 can be invoked by other ITP entities and/or tool set tools 130 to automatically generate a bug report 160 or portions of a bug report 160. In an embodiment the bug handler 225 can report bugs in any available database(s) established for error reporting, including one or more ITP databases 145. In an embodiment the bug handler 225 can automatically and/or via user 150 command forward bug reports 160 to other entities and/or other individuals, e.g., to software systems established for software coders to manage the correction of product version bugs, to error management software systems established for tracking errors and automatically generating reports on identified errors, to other users 150, to product version managers, etc.

In an embodiment the bug handler 225 utilizes input from a user 150 to generate, or populate, a bug report 160. In an embodiment the bug handler 225 also, or alternatively, uses ITP 110 internal and/or accessible information to populate a bug report 160 including, but not

An embodiment ITP 110 includes a reporter 230 component. In an embodiment the reporter 230 aggregates product version 115 and respective test and review data into a consumable form. In an embodiment the reporter 230 generates relevant reports for product versions 115 and their respective tests and review. In an aspect of this embodiment the generated reports reveal known or analysis-discovered connections and views of one or more product versions 115 from various producers' perspectives and the analyzer's perspective. In an embodiment the reporter 230 can generate a variety of reports targeted for, e.g., specific product versions 115, specific product version groups, user 150 review results, product version 115 review results, product and/or product version 115 review statistics, identified and/or suspected errors, specific test cases, specific graphical U/Is 135, error correction, product version error statistics, etc. In an embodiment the reporter 230 can generate reports geared to differing target audiences, e.g., executive level summary reports for upper management, status reports for scheduling groups, detailed bug reports 160 for individuals and/or groups tasked with product maintenance and correction, etc.

In an embodiment the ITP 110 can automatically collect and collate relevant information and produce the results to a target audience, i.e., user 150 or users 150, without the user(s) 150 being required to input and/or investigate to discover these results. For example, in an embodiment the ITP 110 can, based on a populated bug report 160, identify, collect, collate and produce results for a software developer of the subject product that will provide the developer a comprehensive picture of the reported error. The output results can include the affected localized screen 135, i.e., the product version screen 135 that is the subject of the bug report 160, the corresponding English product version screen 135, other product version, e.g., language version, screens 135 with an identified similar error as in the bug report 160, an identification of other product versions 115, e.g., language versions, that are deemed likely to also have the same error, test case results relevant to the error, reviewer information relevant to the affected localized screen 135 and/or identified error, individuals and/or entities that have been notified and/or ought to be notified of the error, etc.

In an embodiment the reporter 230 can automatically generate and output a report 270 to a target audience in one or more formats, e.g., email, phone call, text message, spread sheet, word document, etc. For example, a first target audience may desire one or more reports 270 via email and/or a user 150 may wish to output one or more reports 270 to the first target audience in an email. In this example and an embodiment the reporter 230 automatically maps relevant data for the report 270 to the various email fields, e.g., to, from, subject, body, etc., and sends the email to the respective first target audience email address(es). In an aspect of this embodiment if the reporter 230 cannot discern the proper email field for a particular data item to be included in the report 270 it will automatically include the data item in the email subject and/or body field to ensure that the information is not lost.

As a second example, a second target audience may desire one or more reports 270 be provided to them via a phone message and/or a user 150 may wish to provide one or more reports 270 to the second target audience in a phone call. In this example and embodiment the reporter 230 automatically outputs the relevant report(s) 270 as voice mail to the respective telephone number(s) for the second target audience.

In embodiments the bug handler 225 and/or the reporter 230 of the ITP 110 work to automatically collect and collate relevant information and produce the results to a target audience.

An embodiment ITP 110 includes an external controller 285 component which interacts with technology external to the ITP 110 to augment the ITP's ability to consolidate testing and review for a product. In an embodiment the external controller 285 communicates with the manager 210 to take specific commanded and/or scheduled actions or manage a test or review scenario in a specific commanded and/or scheduled manner.

An embodiment ITP 110 includes data management and filtering subcomponents that are employed to avoid duplicate data input, e.g., to avoid the ITP 110 inputting and/or managing and/or maintaining, duplicate screenshots 135, duplicate bug reports 160 generated by various testers 150, etc.

In an embodiment the ITP 110 manages the onboarding, i.e., inclusion, of new products to the ITP 110 for testing and/or review. In an aspect of this embodiment the ITP 110 utilizes a wizard or wizard-like application(s) to configure a new product and its environment, e.g., new product's language versions, new product's error reporting mechanisms, new product's target audiences for reporting, etc., for proper handling and management within the ITP environment.

In an embodiment the ITP 110 supports screenshot management via one or more of its components. In an embodiment ITP screenshot management includes activities related to product version screenshot handling and management, e.g., setting common properties groups of screenshots 135; ordering of screenshots 135 displayed in various ITP screen 140 views; maintaining, modifying and/or enhancing meta data information for screenshots 135, including, e.g., when a screenshot 135 was captured, how the screenshot 135 was captured, when the screenshot 135 was last modified, whether or not the screenshot 135 is watermarked, etc.; etc.

In an embodiment the ITP 110 supports product management via one or more of its components. In an embodiment ITP product management includes activities related to product onboarding, product management and maintenance within the ITP 110 environment, e.g., keeping track of the various product versions 115 and their testing and review status; tracking product and product version 115 ownership; tracking product and product version 115 test and review schedules and status; etc.

In an embodiment the ITP 110 supports user management via one or more of its components. In an embodiment ITP user management includes activities related to user 150 rights, privileges and activities within the ITP 110 environment, e.g., assigning user privileges to access ITP-supported products and product versions 115; authenticating users 150 attempting to gain access to the ITP 110 and its various supported products and product versions 115; verifying user rights upon user attempts to gain access to ITP-supported products and product versions 115; etc.

In an embodiment where the ITP 110 is used for locality testing and verification the ITP 110 supports language management via one or more of its components. In an embodiment ITP language management includes activities related to handling and grouping ITP product supported languages, e.g., grouping a set of languages, e.g., grouping European languages, grouping Chinese dialects, etc.; generating and maintaining relevant statistics on ITP product supported languages, e.g., identifying how may ITP products have versions in any particular language, etc.; etc.

In an embodiment the ITP 110 authenticates a user 150 prior to allowing the user 150 access to ITP functionality. In an embodiment the ITP 110 checks to see if the requesting user 150 belongs to a group that is allowed access to the ITP 110. In an aspect of this embodiment the ITP 110 authenticates the requesting user's email alias against a preregistered set of alias that can be granted access to the ITP 110.

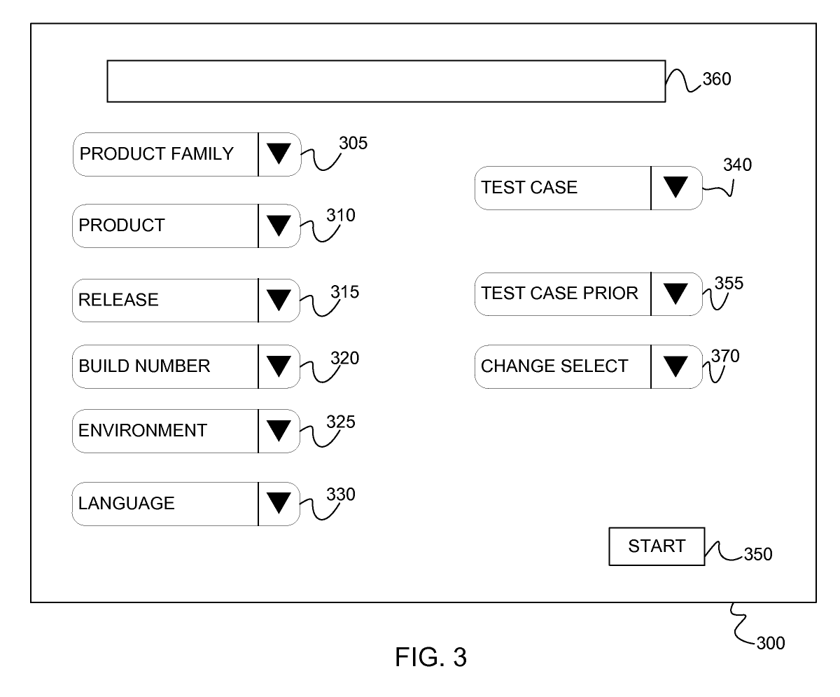

In an embodiment the ITP 110 supports users 150 executing test cases 125 on product versions 115 within the ITP environment. Referring to FIG. 3, an exemplary embodiment test initiation ITP screen 300 is an initial ITP screen 140 that is output to a user 150 once the user 150 has successfully gained access to the ITP 110 and desires to run one or more test cases 125 on an ITP-supported product version 115.

In an embodiment a user 150 selects a product version 115 for testing. In an embodiment, pursuant to identifying a product version 115, a user 150 selects a product family 305. In an embodiment, pursuant to identifying a product version 115, a user 150 selects a product 310 of the product family 305. In an embodiment, pursuant to identifying a product version 115, a user 150 selects a product release version 315. In an embodiment, pursuant to identifying a product version 115, a user 150 selects a product release build version 320. In an embodiment, pursuant to identifying a product version 115, a user 150 selects a product environment 325. In an embodiment, pursuant to identifying a product version 115, a user 150 selects a product language version 330.

In an embodiment a user 150 selects each of the various fields to identify a product version for test, e.g., product family field 305, product field 310, release field 315, build number field 320, environment field 325 and language field 330, by utilizing drop down text boxes on the test initiation ITP screen 300 that identify the various options for each of the product version fields. In an aspect of this embodiment only supported options for each product version field that the current user 150 has been granted access to are made available for the user 150 to select.

In an alternative aspect of this embodiment all supported options for each product version field are available for a user 150 to select. In this alternative aspect if a user 150 chooses an option the user 150 has not been granted access for, i.e., the user 150 chooses a product 310 the user 150 has not been given access to test, then the user 150 will be notified of the improper selection, e.g., an error message will be overlaid upon the test initiation ITP screen 300, etc., and the user 150 will not be able to proceed past the test initiation ITP screen 300 until acceptable field options are selected.

Upon a user 150 identifying a product version for testing through the selection of appropriate options for the product version fields 305, 310, 315, 320, 325 and 330, in an embodiment the selected product version 360 is identified on the test initiation ITP screen 300. In an aspect of this embodiment the selected product version 360 for testing is identified by the various product version options that were chosen by the user 150.

In an embodiment a user 150 selects a test case 340 to run on the selected product version 360. In another embodiment a user 150 can select a set of one or more test cases 340 to run on the selected product version 360.

In an embodiment a user 150 selects a test case 340 by utilizing a drop down text box on the test initiation ITP screen 300 that identifies the test case options for the selected product version 360. In an aspect of this embodiment only supported test case options 340 that the current user 150 has the privilege to run are made available for the user 150 to select.

In an alternative aspect of this embodiment all supported test case options for the selected product version 360 are available for a user 150 to select. In this alternative aspect if a user 150 chooses a test case option the user 150 has not been granted access for, i.e., the user 150 chooses one or more test cases 340 they do not have the privilege to run, then the user 150 will be notified of the improper selection, e.g., an error message will be overlaid upon the test initiation ITP screen 300, etc., and the user 150 will not be able to proceed past the test initiation ITP screen 300 until acceptable test case option(s) 340 is (are) selected.

In an embodiment the user 150 can initiate the execution of the selected test case(s) 340 by activating, e.g., clicking on, a start control widget 350 on the test initiation ITP screen 300. Thereafter the selected test cases 340 will be executed, product screens 135 that are output per the executed test cases 125 will be captured and stored, test case results will be generated and maintained, and relevant statistics, e.g., test case(s) run, identification of user initiating the execution of a test case, test case execution date and time, etc., will be derived and saved.

In embodiments there are additional and/or differing options a user 150 can select for causing the ITP 110 to execute specific test cases 125. In an embodiment the test cases 125 for a product version 115 are prioritized and a user 150 can select a test case priority option 355 to run the next, or group of next, higher priority test cases 125 that have yet to be executed. In an aspect of this embodiment test cases 125 are prioritized via input from users 150 and/or other entities. In an aspect of this embodiment the ITP 110 can automatically prioritize or assist in the prioritization of test cases 125 using relevant information accessible to the ITP 110.

In an embodiment a user 150 can choose a change selectivity option 370 to run one or more test cases 125 on one or more product versions 115 that have new and/or modified screens 135, including new product versions 115 and product versions 115 that have been modified pursuant to prior bug reports 160. In this embodiment a user 150 can quickly and efficiently concentrate on testing, and subsequently reviewing, new and/or modified product versions 115 and product version aspects.

In embodiments additional options a user 150 may be provided to select for causing the ITP 110 to execute one or more specific test cases 125 include an option to execute one or more test cases relevant to product screens 135 previously reviewed by specific reviewers and/or reviewer groups; an option to execute one or more test cases 125 on product versions 115 that have been identified as likely to have a bug similar to the error in a specific bug report 160; etc.

In an embodiment a user 150 selects offered testing options by utilizing drop down text boxes on the test initiation ITP screen 300.

In an embodiment the ITP 110 supports users 150 reviewing product screens 135 that have been captured and saved as the result of executed test case(s) 125 on product versions 115 within the ITP environment. Thus, in an embodiment the ITP 110 supports users 150 viewing and reviewing product screens 125 and associated properties thereof, including, but not limited to, associated bug reports 160, relevant test case information and statistics, associated test case execution results, etc.

In an embodiment the ITP 110 supports users 150 reviewing product screens 135 that have been previously generated and are imported to or otherwise accessible to the ITP 110. In an embodiment a user 150 can utilize the ITP 110 to review previously generated product screens 135 that have no, or incomplete, accompanying meta data. In an aspect of this embodiment the ITP 110 automatically generates relevant meta data that can be extracted from, or otherwise gleaned from, a user's review.

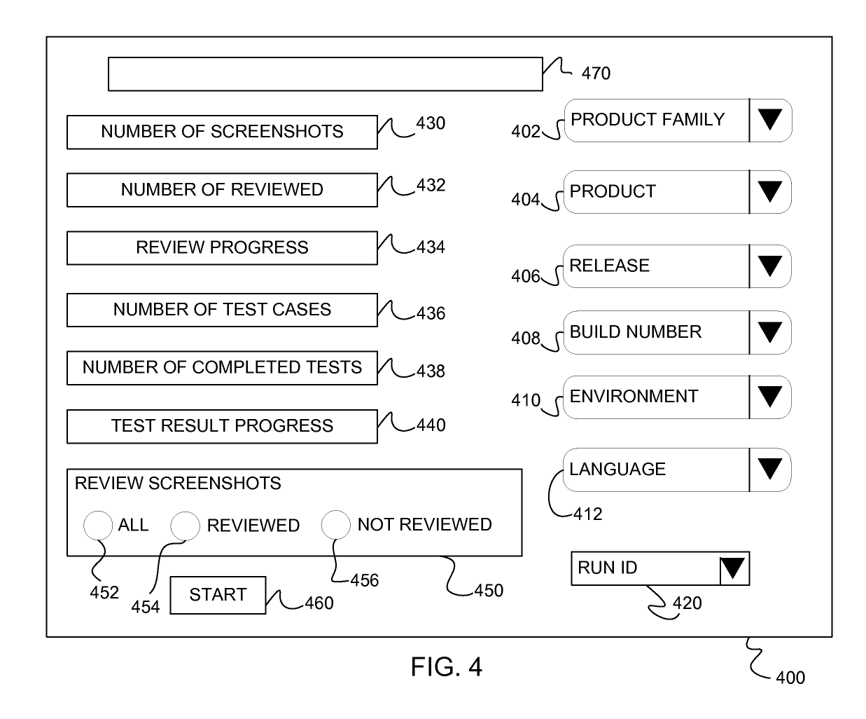

Referring to FIG. 4, an exemplary embodiment review initiation ITP screen 400 is an initial ITP screen 140 that is output to a user 150 once the user 150 has gained proper access to the ITP 110 and desires to review one or more product version screens 135.

In an embodiment a user 150 selects a product version 115 for review. In an embodiment, pursuant to identifying a product version 115, a user 150 selects a product family 402. In an embodiment, pursuant to identifying a product version 115, a user 150 selects a

In an embodiment a user 150 selects each of the various fields to identify a product version 115 for review, e.g., product family field 402, product field 404, release field 406, build number field 408, environment field 410 and language field 412, by utilizing drop down text boxes on the review initiation ITP screen 400 that identify the various options for each of the product version fields. In an aspect of this embodiment only supported options for each product version field that the current user 150 has privileges for are made available for the user 150 to select.

In an alternative aspect of this embodiment all supported options for each product version field are available for a user 150 to select. In this aspect of this embodiment if a user 150 chooses an option they do not have privileges for then the user 150 will be notified of the improper selection, e.g., an error message will be overlaid upon the review initiation ITP screen 400, etc., and the user 150 will not be able to proceed past the review initiation ITP screen 400 until acceptable field options are selected.

In an embodiment, once a user 150 has selected proper product version options, i.e., options for fields 402, 404, 406, 408, 410 and 412, a run id 420 is to be identified by the user 150 if there are two or more sets of screenshots 135 for the identified product version 470. In an embodiment a user 150 identifies a run id 420 by utilizing a drop down text box on the review initiation ITP screen 400 that identifies the run id options for the selected product version 470.

In embodiments a user 150 is provided additional and/or differing review options, e.g., new and/or modified screens 135 that have not been previously reviewed in one or more product versions 115; passed screens 135 for one or more product versions 115, i.e., screens 135 that have been previously reviewed, either manually or automatically by the ITP 110, and have been determined to be correct; failed screens 135 for one or more product versions 115, i.e., screens 135 that have been previously reviewed, either manually or automatically by the ITP 110, and have been determined to have an error in them; error likely screens 135, i.e., screens 135 that have been determined to have a likelihood of the same error as identified in one or more specific bug reports 160; screens 135 previously reviewed by one or more specific reviewers or reviewer groups; etc.

In an embodiment a user 150 selects offered review options by utilizing drop down text boxes on the review initiation ITP screen 400.

Upon a user 150 identifying their review option(s), in an embodiment the selected product version(s) 470 is (are) identified on the review initiation ITP screen 400.

Upon a user 150 identifying a product version(s) 470 for review, in embodiments one or more test statistics 165 for the selected product version(s) 470 are output on the review initiation ITP screen 400. In an embodiment a first test statistic presented to a user 150 for a selected product version(s) 470 is the number of product version screenshots 430 there are.

In an embodiment a second test statistic presented to a user 150 for each selected product version 470 is the number of screenshots that have previously been reviewed 432 for the product version 470. In an embodiment a third test statistic presented to a user 150 for each selected product version is a review progress 434 which is the percentage of already reviewed screenshots 432 out of the total number of product version screenshots 430.

In an aspect of this embodiment the number of screenshots previously reviewed 432 and the review progress 434 identify the number of product version screenshots 135, and percentage, that have been reviewed by any user 150 to date. In an alternative aspect of this embodiment the number of product version screenshots 135 previously reviewed 432 and the review progress 434 identifies the number of product version screenshots 135, and percentage, that have been reviewed by the current user 150 to date.

In an embodiment a fourth test statistic presented to a user 150 for each selected product version 470 is the number of product version test cases 436 there are.

In an embodiment a fifth test statistic presented to a user 150 for each selected product version 470 is the number of test cases that have been previously run and completed 438, i.e., marked as passed or failed, for the product version 470.

In an embodiment a sixth test statistic presented to a user 150 for each selected product version 470 is a test result progress 440. In an embodiment the test result progress 440 is the pass rate which indicates the number of existing test cases 125 that have already been run

In other embodiments additional or different relevant test statistics 165 for each selected product version 470 are presented to the user 150, e.g., the number of screenshots 135 for a selected product version 470 that have passed a review; the number of screenshots 135 for a selected product version 470 that have failed a review, i.e., have at least one error; etc.

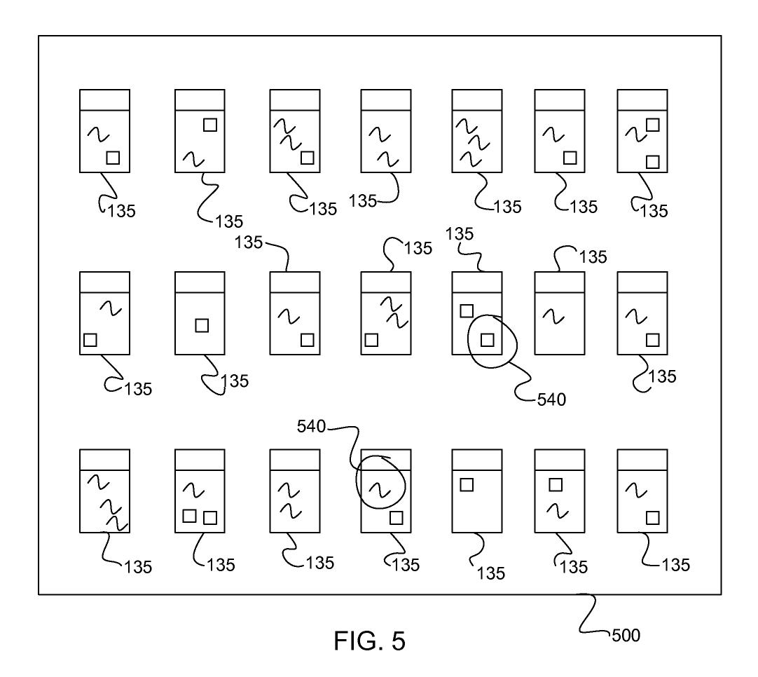

In an embodiment the review initiation ITP screen 400 provides a user 150 screenshot review options 450. In an embodiment one screenshot review option is all screenshots 452 for the selected product version(s) 470. In this embodiment, upon the user 150 selecting the all review screenshot option 452 and then activating, e.g., clicking on, a start control widget 460 on the review initiation ITP screen 400 an ITP screen 140 that displays all the screenshots 135 for each selected product version 470 will be output. In an aspect of this embodiment a separate ITP screen 140 is output for each selected product version 115 and the user 150 can navigate between the various ITP all screenshots review screens. An example of a resultant all screenshots review ITP screen 500, also referred to herein as a pivot view, is further discussed below with reference to FIG. 5.

In an embodiment a second screenshot review option is reviewed screenshots 454 for each selected product version 470. In an aspect of this embodiment, upon the user 150 selecting the reviewed screenshots option 454 and the start control 460 an ITP screen 140 that displays the screenshots 135 for the selected product version(s) 470 that were previously reviewed by any user 150 is output. In an alternative aspect of this embodiment, upon the user 150 selecting the reviewed screenshots option 454 and the start control 460 an ITP screen 140 that displays the screenshots 135 for the selected product version(s) 470 that were previously reviewed by the current user 150 is output. In aspects of this embodiment a separate ITP screen 140 is output for each selected product version 115 and the user 150 can navigate between the various ITP reviewed screenshots review screens.

In an embodiment a third screenshot review option is not reviewed screenshots 456 for the selected product version 470. In an aspect of this embodiment, upon the user 150 selecting the not reviewed screenshots option 456 and the start control 460 an ITP screen 140 that displays the screenshots 135 for the selected product version(s) 470 that have not yet been reviewed by any user 150 is output. In an alternative aspect of this embodiment, upon the user 150 selecting the not reviewed screenshots option 456 and the start control 460 an ITP screen 140 that displays the screenshots 135 for the selected product version(s) 470 that have not yet been reviewed by the current user 150 is output. In aspects of this embodiment a separate ITP screen 140 is output for each selected product version 115 and the user 150 can navigate between the various ITP not reviewed screenshots review screens.

Referring to FIG. 5, the ITP 110 can generate and output a pivot view 500 of all known screen shots 135 for a specific product version simultaneously by, e.g., a user 150 selecting the all screenshots option 452 of an embodiment review initialization ITP screen 400 depicted in FIG. 4. In an aspect of an embodiment pivot view 500 the ITP 110 includes snapshot views of each screen 135 for a selected product version 470. In an aspect of an embodiment pivot view 500 the ITP 110 includes snapshot views of each screen 135 of a selected product version 470 with suspected discrepancies, i.e., errors, identified 540. In an aspect of this embodiment prior identified discrepancies are indicated on the respective screens 135 of a selected product version 470.

In an embodiment the ITP 110 creates the xml, i.e., the encoding of screenshots 135 in machine-readable form, for use in generating the user-requested pivot view. In an aspect of this embodiment the ITP 110 creates the xml and utilizes, or otherwise interacts with, a pivot creation application to create the requisite pivot view for output to a user 150 within the ITP 110 environment.

Using a pivot view 500 a user 150 can quickly, easily and efficiently review and analyze all the screens 135 for a selected product version 470 at one time. The exemplary pivot view screen 500 provides a user 150 a unique global view of a product version 115.

In an embodiment a user 150 can review screens 135 of a pivot view 500 and can identify errors therein by, e.g., clicking on the component(s) of the screen(s) 135 the user 150 determines are in error. In an aspect of this embodiment when a user 150 identifies a screen component as having a discrepancy a bug report generator of the bug handler 225 of FIG. 2, also referred to herein as a bug wizard, is activated. Embodiment bug reporting is discussed below with reference to FIG. 8.

In an embodiment the ITP 110 provides a user 150 the ability to review and report on screens 135 of a product version 115, e.g., indicate whether a screen 135 passes, with no errors, or fails, with at least one identified error, directly from within a pivot view such as exemplary pivot view screen 500. In an aspect of this embodiment screen reporting is accomplished by the identification of a screen 135 with a pass or fail designation based on the coordinate of the screen 135 within the pivot view and the user 150 mouse click location(s).

In an embodiment a user 150 can choose one screen 135 of a pivot view 500 to review and a new ITP screen 140 with the selected product screen 135 will be displayed. A user 150 can then designate the screen 135 as passing, i.e., having no errors, or identify any errors therein. For example, and referring to FIG. 6, the result of a user 150 review of a selected product version screen 135 in an ITP 110 environment is depicted in exemplary screen 605. In the example of FIG. 6, a specific exemplary product version screen 605 has three errors which are identified 640 by a user 150. In an embodiment a user 150 can click on a screen component, e.g., by utilizing a mouse placed on the component, to indicate that the component is in error.

Exemplary screen 650 illustrates what product screen 605 is designed to look like, per, e.g., relevant design file(s) 120, U/I software file(s) 105, etc.

As can be seen in the example of FIG. 6, “custom color” box 610 is misplaced in the selected product version 470. Rather than being located in the top left-hand corner as shown in product version screen 605, “custom color” box 610 was designed to be located in the top right-hand corner correctly depicted by “custom color” box 660 of screen 650.

In an embodiment identified errors are circled 640 on a screenshot 135 of a selected product version 470. In an aspect of this embodiment identified errors are circled 640 in a color, e.g., red, green, white, etc. In other embodiments identified errors in screenshots 135 are indicated 640 in ITP screens 140 in other manners, e.g., identified erroneous components are bounded by rectangles in a given color, overlaid with text in a given color and font, highlighted, shaded, bolded, pointed to with arrows, enclosed in custom strokes, etc.

In an embodiment erroneous components of a screenshot 135, or screen areas, are enclosed in custom strokes to assist in identifying the error(s). In an embodiment custom text in a given color and font is overlaid on a screenshot 135 with at least one identified error to assist in identifying the screenshot error(s).

In the example of FIG. 6 “this widget for is” text box 620 is also identified 640 as erroneous. Referring to screen 650, the correct grammar for this text box is “this screen is for . . . ” text box 670, per, e.g., relevant design file(s) 120, U/I software file(s) 105, etc.

In the example of FIG. 6 “press exit to return to ma” text box 625 of product screen 605 is the third error identified 640 for the selected product version 470. Referring again to screen 650, text box 625 has been erroneously truncated and should properly be “press exit to return to main menu” text box 675 of screen 650, per, e.g., relevant design file(s) 120, U/I software file(s) 105, etc.

In an embodiment the ITP 110 generates for display product screen 605 with the identified errors 640, and saves the marked screen 605 for future and others use in, e.g., a database 145. In an embodiment the ITP 110 outputs screen 605 to the user 150 currently working with the relevant product version 115.

Referring again to FIG. 5, in an embodiment a user 150 can select a subset of one or more screens 135 of the pivot view 500 to review simultaneously and a new ITP screen 140 with the selected product screens 135 will be displayed.

In an embodiment a user 150 can select one or more screens 135 of the pivot view 500 and indicate that the selected product version screens 135 pass.

In an embodiment a user 150 can select one or more screens 135 of the pivot view 500 and indicate that the selected product version screens 135 have errors, i.e., they fail.

In an embodiment a user 150 can select one product screen 135 of a pivot view 500 for review and thereafter request that all, or some subset, of the same screen 135 for other product versions 115, e.g., the same screen 135 in other language product versions 115, be output; i.e., that a cross language view be generated and output. In this embodiment the ITP 110 generates a new ITP screen 140 that includes the same screen 135 for the various requested product versions 115; i.e., the requested cross language view.

As previously noted, the ITP 110 can thus provide users 150, and other entities, a global view of product versions across various builds, languages, environments, etc.

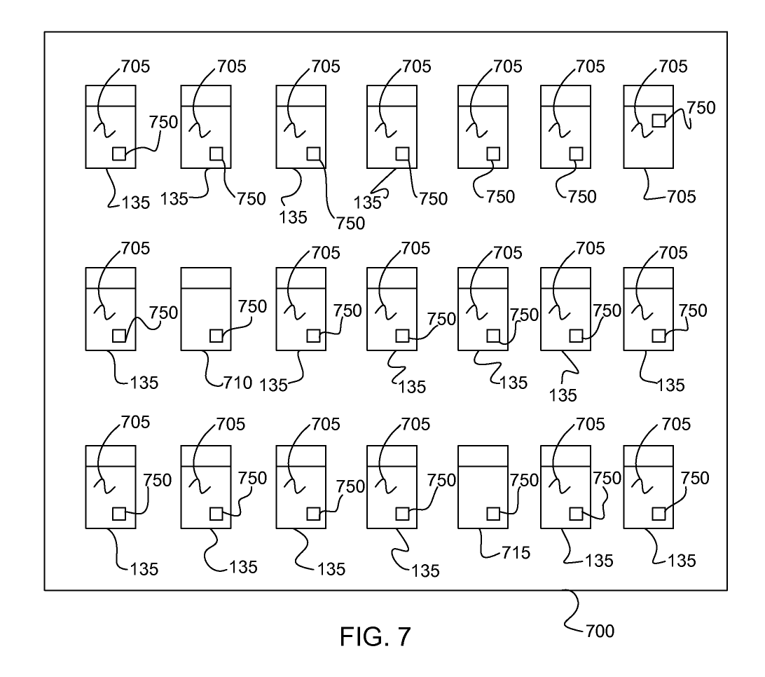

For example, and referring to FIG. 7, ITP screen 700 is an exemplary ITP screen 140 that is generated and output by an embodiment ITP 110, and which is a cross language view of the various versions of one screen 135 of a product, each one generated by a different product version 115. In the example of FIG. 7, ITP screen 700 displays one screen shot 135 for each product language version 115. In this manner a user 150 can easily and efficiently simultaneously review and analyze, e g., manually, all versions of one screen 135 for a product.

In this embodiment a user 150 can quickly identify discrepancies in a screen 135 for different product versions 115. For example, screen shot 705 depicts component button 750 in a different position, upper right corner, than the majority of other identified screenshots 135 wherein the same button 750 is located in the lower right-hand screen corner. As a second example, screenshots 710 and 715 both fail to depict component text 705, which is otherwise present in the remainder screenshots 135 and 705 shown in ITP screen 700. As can be seen by a quick review of FIG. 7, a user 150 can easily and efficiently look at a cross language view ITP screen 700 and identify differences in the same screen 135 of various product versions 115.

In the example of FIG. 7 the same screen 135 for all known product language versions 115 within the ITP 110 environment is depicted in the cross language view ITP screen 700. In an embodiment the ITP 110 can generate other ITP screens 140 with subsets of the screenshots 135 depicted in exemplary cross language view ITP screen 700, e.g., a side-by-side comparison view of a screenshot 135 from two differing product versions 115, e.g., two languages, two builds, etc.; only those screens 135 for the language versions 115 chosen by a user 150; the screens 135 for the language versions in a geographic group, e.g., Western Europe, South America, etc.; only those screens 135 with prior identified errors; only those screens 135 with a specific prior identified error; etc.

As with a pivot view, in an embodiment a user 150 can select one or more screens 135 of any ITP screen shot view, e.g., cross language view, side-by-side comparison view, etc., and indicate that the selected product version screens 135 pass.

As with a pivot view, in an embodiment a user 150 can select one or more screens 135 of any ITP screen shot view, e.g., cross language view, side-by-side comparison view, etc., and indicate that the selected product version screens 135 have errors, i.e., they fail.

In an embodiment the ITP 110 can render review screen subset selections based on analysis performed by, e.g., the analyzer 205 of the ITP 110. For example, upon a user 150 identifying an error in a screenshot 135 for one particular product language version 115, the ITP 110, upon analysis of the identified error and its product version 115, can suggest a subset of one or more other screens 135 in the same product version 115 and/or a subset of one or more screens 135 in other product versions 115 for review. In an embodiment an ITP review screen subset selection is generated based on the analytical probability that the screens 135 of the review screen subset selection may have the same, or similar, errors to a current screen 135 under review by the user 150.

As previously indicated, with any ITP screen 140 that simultaneously displays multiple screenshots 135, e.g., screen 500 of FIG. 5 or screen 700 of FIG. 7, in an embodiment a user 150 can choose one pictured screenshot 135 to magnify at any one time by, e.g., clicking on the desired displayed screenshot 135 in the ITP screen 140.

In an embodiment the ITP 110 can automatically populate a bug report 160 for an identified error on a screen shot 135. In an embodiment the ITP 110 can automatically populate one or more portions of a bug report 160 for an identified error on a screen shot 135. In an embodiment the ITP 110 can assist a user 150 to generate a bug report 160 on an identified discrepancy for a product version 115. In an embodiment the ITP 110 collates, groups across one or more indices, and stores for future and other's reference, generated bug reports 160.

Referring to FIG. 8, a bug report generator of the bug handler 225 of FIG. 2, also referred to herein as a bug wizard, provides one or more ITP screens 140 for a user 150 and/or a user 150 and the ITP 110, through automatic field population, to generate a bug report 160 for an identified discrepancy or error, collectively referred to herein as identified bug, in a product version 115.

ITP screen 800 is an exemplary embodiment bug report template that a user 150 and/or a user 150 and the ITP 110, through automatic field population, can complete to generate a bug report 160. In an embodiment box 810 of exemplary ITP screen 800 can be checked if there is already a bug report 160 in existence for the currently identified error and the user 150 and/or ITP 110 wishes to augment and/or modify the information for the previously identified issue.

In an embodiment pull-down box 820 of exemplary ITP screen 800 allows a user 150 and/or the ITP 110 to identify the product and/or product version 115 that has the bug and/or the test case 125 or test suite that was run when the bug was identified.

In an embodiment the user 150 and/or the ITP 110 can include reporting information with the bug report 160 that informs whom, i.e., which individuals, groups and/or entities, ought to be advised of the bug report 160. In an embodiment the user 150 and/or the ITP 110 can include other administrative information related to the bug report 160, e.g., the date the bug report 160 is generated, the identify of the user 150 generating the bug report 160, the environment in which the bug report 160 is generated, etc. In aspects of this embodiment reporting and administrative bug report information is automatically input for a bug report 160 by the ITP 110. In aspects of this embodiment reporting and other administrative bug reporting information is input by a user 150 via text, pull down menus, check boxes, etc. In aspects of this embodiment reporting and other administrative bug reporting information is stored as meta data for the respective bug report 160.

In an embodiment box 830 of the exemplary ITP screen 800 allows a user 150 to choose a category for the currently identified bug. In an embodiment various predetermined bug categories are suggested to the user 150 and the user 150 can choose the category for the identified error. In an embodiment, if no suggested bug category correctly describes the currently identified error the user 150 can select an “other” error option 895.

In an embodiment one or more exemplary ITP screens 140 depicting an error, or errors, of the chosen bug category are output to the user 150 for the user 150 to utilize to confirm to themselves that they have selected a descriptive bug category for the current error being reported. In this manner a user's bug category choice can be affirmed which can be helpful to, e.g., new users, non-expert users, casual users, users who have not worked with bug reporting in some time, non-English proficient users, etc.

In an embodiment the ITP 110 can suggest a bug category for a user 150, by, e.g., highlighting, bolding, font coloring, font sizing, framing, etc., the suggested bug category option on exemplary ITP screen 800. In an embodiment the ITP 110 can automatically select the bug category for a current error being reported. In aspects of these embodiments the ITP 110 can utilize information related to the identified error and other relevant historical data to identify a bug category for the current error being reported.

In an embodiment locality testing environment, where screenshots 135 for product version(s) 115 are being checked to ensure the language and graphics displayed therein are correct across the product versions 115, one embodiment predetermined error category option is clipping 805. In an embodiment a clipping error 805 descriptor indicates that one or more characters of portrayed text in a product screen 135 are improperly clipped, i.e., a portion of the top and/or bottom of the character(s) is cutoff.

An embodiment second predetermined error category option for an embodiment locality testing environment is directionality 815. In an embodiment a directionality 815 error descriptor indicates that the flow of letters in a product screen 135 is incorrect, e.g., the letters of a depicted phrase go from top-to-bottom when they should be positioned left-to-right.

An embodiment third predetermined error category option for an embodiment locality testing environment is layout 825. In an embodiment a layout 825 error descriptor indicates that the organization of a product screen's information, i.e., product screen components, appears incorrect, i.e., one or more screen components are incorrectly ordered; i.e., laid out, in a product screen 135. As previously discussed, product screen components can consist of text, e.g., static text, editable text fields, text boxes, etc., control icons, also referred to herein as control widgets, e.g., radio buttons, check boxes, scrollbars, etc., and graphical items, e.g., pictures, symbols, etc. An example of a layout error 825 is a radio button positioned in the top left-hand corner of a product screen 135 when the user 150 believes it should be properly located in the bottom right-hand corner.

An embodiment fourth predetermined error category option for an embodiment locality testing environment is non-localized 835. In an embodiment a non-localized 835 error descriptor indicates that the presented text language of a product screen 135 is not in the proper target language, e.g., the text is in English for a Spanish product version 115.

An embodiment fifth predetermined error category option for an embodiment locality testing environment is overlap 845. In an embodiment an overlap 845 error descriptor indicates that two or more product screen components are improperly overlaid to some extent upon a product screen 135.

An embodiment sixth predetermined error category option for an embodiment locality testing environment is truncation 855. In an embodiment a truncation 855 error descriptor indicates that an end, i.e., right-side, left-side, top, or bottom, of a product screen component is improperly shortened.

An embodiment seventh predetermined error category option for an embodiment locality testing environment is character error 865. In an embodiment a character error 865 error descriptor indicates that a character, e.g., “n”, is incorrectly portrayed on a product screen 135 for the target product version, e.g., Cyrillic, language, e.g., “π”.

An embodiment eighth predetermined error category option for an embodiment locality testing environment is loc quality 875. In an embodiment a loc quality 875 error descriptor indicates that the quality of the localization of portrayed text in a product screen 135 is unacceptable and can include errors such as unexpected and/or unacceptable punctuation, inconsistent wording, etc.

An embodiment ninth predetermined error category option for an embodiment locality testing environment is automation infrafail 885. In an embodiment an automation infrafail 885 error descriptor indicates that there is an infrastructure failure that can result in, e.g., a product screen 135 being displayed at an unexpected time, a product screen 135 failing to be displayed at an expected time, etc.

In other embodiment locality testing environments additional or alternative sets of predetermined error category options are presented to a user 150 for use in bug reporting.

In other embodiment testing environments alternative sets of predetermined error category options can be presented to a user 150 for use in bug reporting.

In an embodiment text box 870 can be written to by a user 150 to include additional information about, or relevant to, the error that is the subject of the bug report 160, e.g., the actual bug of the product screen 135, user comments, user suggestions for error correction, etc. In an embodiment the information input to text box 870 becomes a part of the bug report 160.

In an embodiment box 840 of exemplary ITP screen 800 can be clicked on by a user 150 when the user 150 desires to go to a next, new, bug report screen 800. In this manner a user 150 can sequentially generate bug reports 160 for various errors discovered during testing without being required to launch the bug report generator each time.

In an embodiment box 850 of exemplary ITP screen 800 can be clicked on by a user 150 when the user 150 has finished generating bug reports 160.

In an embodiment box 860 of exemplary ITP screen 800 can be clicked on by a user 150 when the user 150 wishes to cancel the current bug reporting session and delete the current bug report 160 being working on.

In other embodiments additional or alternative sets of control icons are present on the ITP screen 140 used for guiding the generation of bug reports 160.

In an embodiment the screen 135 with the error that is the subject of a generated bug report 160 is automatically included with, and/or referenced, and becomes a part of the bug report 160. In an embodiment additional relevant screen(s) 135 can be commanded to be, or, alternatively, are automatically, included with, and/or referenced, and become a part of the bug report 160, e.g., the corresponding English language product version screen 135 for the current product version screen 135 with the error being reported, etc.

In an embodiment the ITP 110 can utilize information accessed from other databases and environments to assist in generating bug reports 160 and bug report information, e.g., identities of whom should be apprised of a generated bug report 160, etc.

In an embodiment the ITP 110 automatically notifies identified individuals, groups and entities of a generated bug report 160. In an embodiment the ITP 110 automatically outputs a generated bug report 160 to identified individuals, groups and entities.

In an embodiment a user 150 can access a myriad of information related to a product, product version, or versions, 115, a product screen 135, test cases 125 and testing analysis, other users 150 ITP activities, product errors, bug reports 160, test tools 130, etc., all from the ITP 110 environment.

In an embodiment the ITP 110 can provide a user 150, via one or more ITP screenshots 140, meta data for a product, product version 115, product version screen 135, test case 125, bug report 160, etc.

In an embodiment the ITP 110 can provide a user 150, via one or more ITP screenshots 140, ITP automatically generated analysis and results for a product, product version 115, product version screen 135, product version error, etc.

In an embodiment the ITP 110 can provide a user 150, via one or more ITP screenshots 140, user 150 and/or other user 150 generated analysis and results for a product, product version 115, product version screen 135, product version error, etc.

In an embodiment the ITP 110 can provide a user 150, via one or more ITP screenshots 140, ITP automatically generated and/or user generated product, product version 115 and scheduling statistics, including, but not limited to, the pass/fail rate for a product and/or product version 115; test schedule status for a product and/or product version 115; an identification of product version screens 135 suggested to be priority reviewed in light of, e.g., current testing schedules and status, etc.; an identification of the users 150 that have been reviewing a product or product version 115 in a specific time frame, e.g., within the last week, etc.; etc. More generally, in an embodiment the ITP 110 can provide a user 150 any information relevant to an ITP-supported product and its testing and review that has been input or otherwise rendered accessible to the ITP 110 or has been generated, either automatically by the ITP 110 and/or manually by a user 150, within the ITP environment.

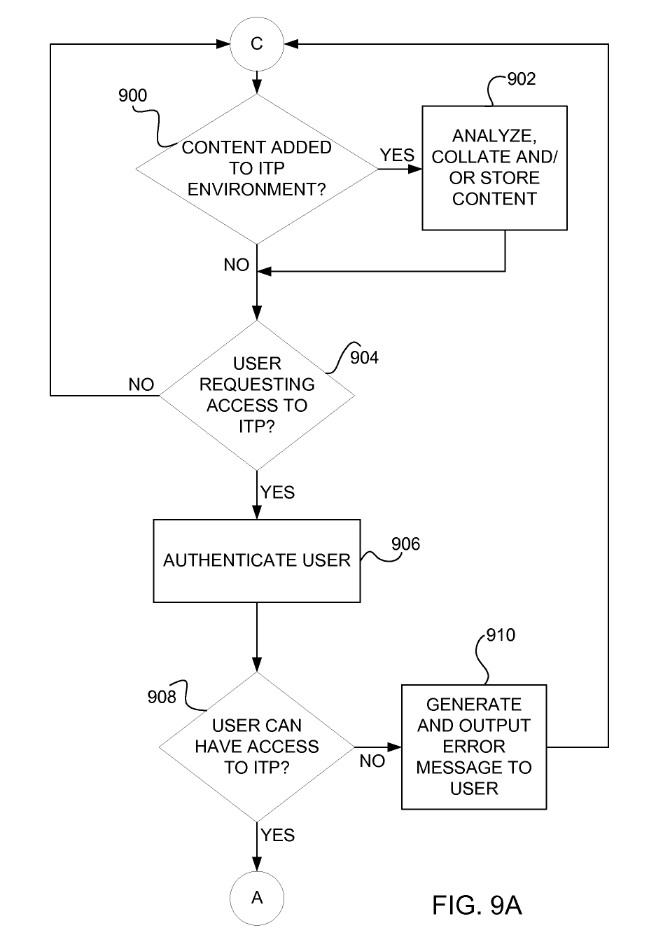

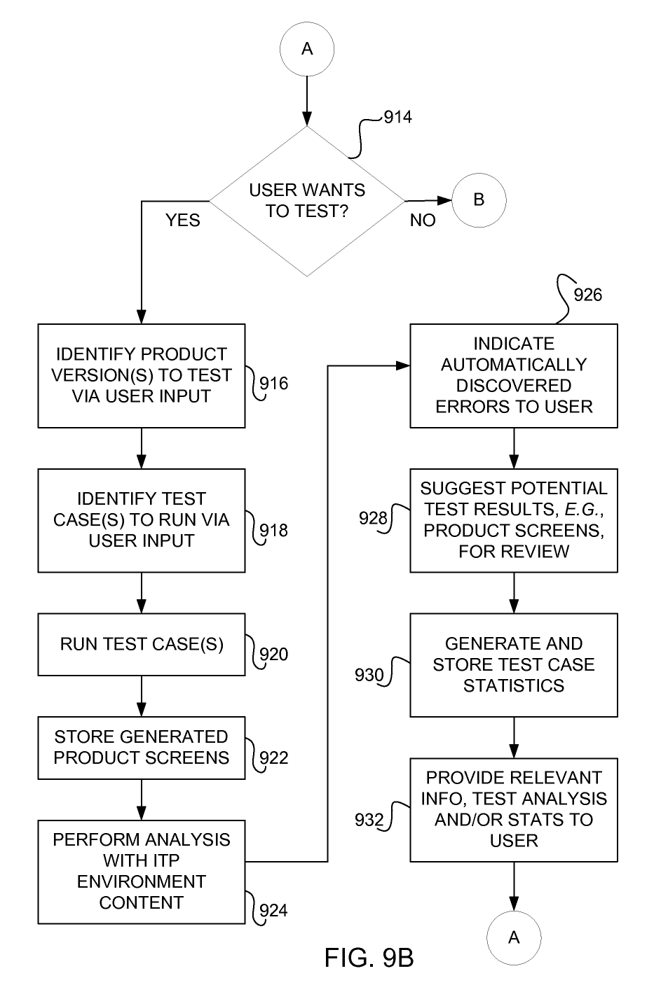

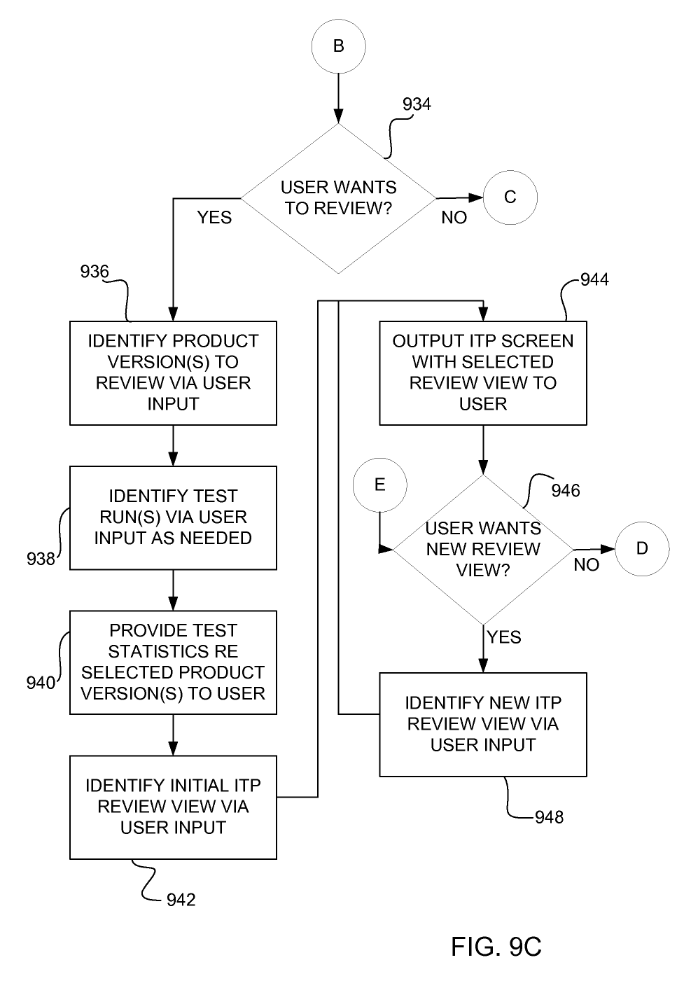

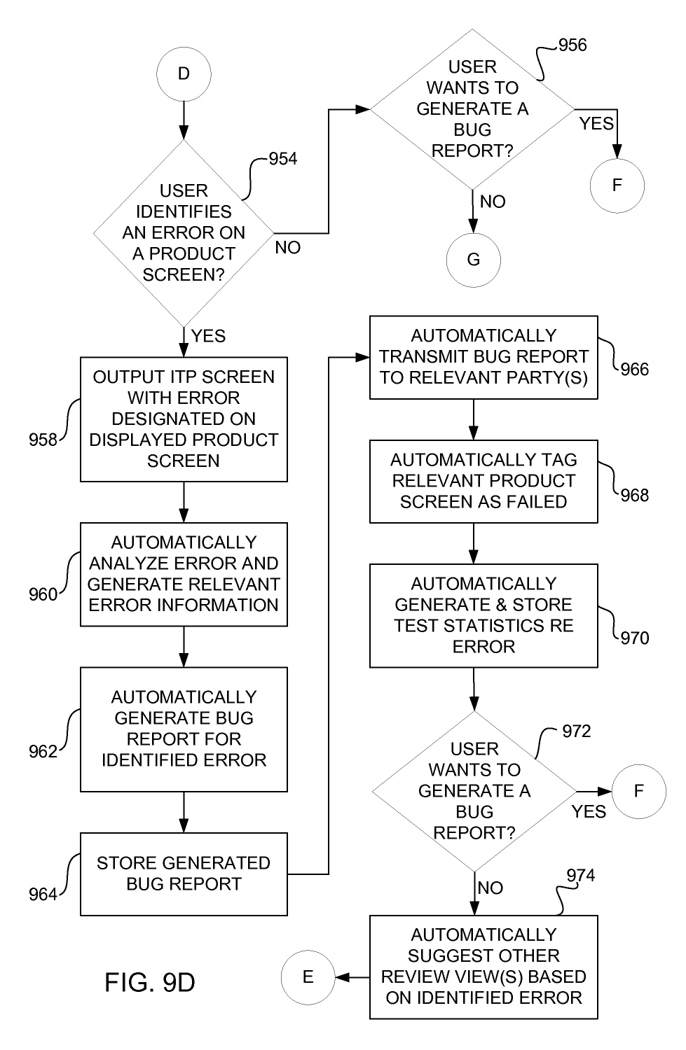

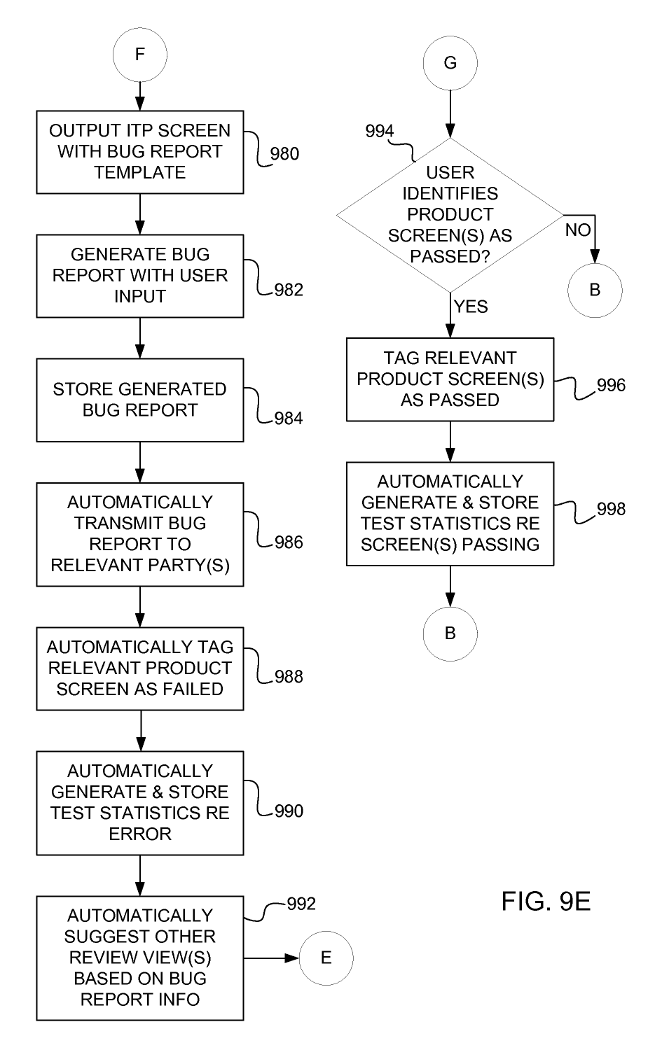

Referring to FIGS. 9A-9E, an embodiment logic flow illustrates an ITP methodology supporting product testing and review. In the embodiment of FIGS. 9A-9E the ITP 110 supports locality testing and review, i.e., for correct product version language usage, utilizing product version screenshots 135 as a main product component for determining pass/fail status. In other embodiments an ITP 110 can support other product reviews and/or use other product components or groups of product components for determining pass/fail and/or other status.

Referring to FIG. 9A, in an embodiment at decision block 900 a determination is made as to whether content is being added to, or otherwise introduced to or made available to, the ITP environment. As examples, one or more test cases 125, one or more new or newly modified tools 130, one or more U/I software files 105, etc., can be added to the ITP environment at any given time, either directly or via reference thereto. In an aspect of this embodiment a user 150 can direct, or otherwise command, the inclusion of, or reference to, new content to the ITP 110. In an aspect of this embodiment the ITP 110 can automatically gather new content, or references thereto, as the new content becomes available and the ITP 110 becomes aware of it, e.g., through built-in notification systems, etc.

If at decision block 900 new content is being added to the ITP environment then in an embodiment the new content is analyzed, collated and/or stored for use within the ITP environment 902.

If at decision block 900 new content is not currently being added to the ITP environment then in an embodiment at decision block 904 a determination is made as to whether a user is requesting access to the ITP. If no, the ITP will wait for new content to be added to its environment 900 and/or a user to attempt to gain access to the ITP 904.

If a user is attempting to access the ITP then in an embodiment the ITP authenticates the user 906 to ensure the user has the proper privilege for ITP access and to determine what aspects, e.g., testing only, review only, testing and review, etc., and/or content, e.g., only English product versions, only Build X versions, etc., the user will be granted access to.

In an embodiment at decision block 908 a determination is made as to whether the current user has been authenticated and can properly access the ITP. If no, in an embodiment a message is generated and output indicating the user will not be granted ITP access 910.

If at decision block 908 the user has been properly authenticated then in an embodiment and referring to FIG. 9B, at decision block 914 a determination is made as to whether the user wants to run one or more tests for a product version(s). If yes, in an embodiment the product version(s) to test is identified via input by the user 916. In an aspect of this embodiment the product version(s) to test is identified by user input as described with reference to FIG. 3 above.

In an embodiment the test case(s) to run is identified via user input 918. In an aspect of this embodiment the test case(s) to run is identified by user input as described with reference to FIG. 3 above.

In an embodiment the user selected test case(s) is run 920. In an embodiment product version screens output by the product version under test during the executed test case(s) are stored 922. In an aspect of this embodiment generated product version screens are stored in one or more ITP databases 145.

In an embodiment automatic analysis on the generated product screens is performed within the ITP 924. In an aspect of this embodiment the ITP analyzer 205 automatically analyzes product screens 135 generated pursuant to test runs. In an aspect of this embodiment the ITP analyzer 205 uses the output of the execution of one or more software tools 130 of the ITP producer 280 on generated product screens 135 to produce test analysis and/or statistics. In an aspect of this embodiment the ITP analyzer 205 utilizes statistics, analysis and results generated by the user 150 and/or other users 150 for related, or other relevant, screens 135, e.g., the same screen 135 in other product versions 115, to produce, or produce additional, test analysis and/or statistics.

In an embodiment the ITP indicates to the user errors that are automatically discovered within one or more generated product screens as a result of ITP analysis 926. In an aspect of this embodiment the ITP 110 generates one or more ITP screens 140 containing product version screens 135 with automatically discovered errors identified therein. In an aspect of this embodiment automatically discovered errors in product version screens 135 are denoted as described with reference to FIG. 6.

In an embodiment the ITP, pursuant to the executed test case(s) and relevant analysis, identifies and suggests potential test results, e.g., product version screens, that the user may wish to review 928. For example, based on analysis of the product version screens 135 generated

In an embodiment the ITP automatically generates and stores test case statistics based on, e.g., the test case(s) run, test case-generated output, etc., 930. Exemplary generated test case statistics include an identification of the test case 125 run, the date of the test case 125 execution, the percentage of the number of test cases 125 for a product version 115 that have already been run on the product version 115, etc. In an aspect of this embodiment generated test case 125 statistics are stored in one or more ITP databases 145.

In an embodiment the ITP, either automatically or pursuant to user command, can output to the user a variety of relevant information, test analysis and statistics for the product version(s) under test and test case(s) run 932. This information, test analysis and statistics can include content supplied to, or otherwise referenced by, the ITP 110, automatically generated by the ITP 110 and/or generated pursuant to the user 150 and/or other user ITP input.

In an embodiment control returns to decision block 914 where a determination is once again made as to whether the user wants to test a product version(s).

If at decision block 914 the user does not want to test, then in an embodiment, and referring to FIG. 9C, a determination is made as to whether the user wants to review, e.g., product version screens, 934. If yes, in an embodiment the product version(s) to review is identified via input by the user 936. In an aspect of this embodiment the product version(s) to be reviewed is identified by user input as described with reference to FIG. 4 above.

In an embodiment if there exists more than one set of product version components, e.g., screens, that can be reviewed for the user-selected product version(s) then the test run output to be reviewed is identified via user input 938. In an aspect of this embodiment the test run output to be reviewed is identified by user input as described with reference to FIG. 4 above.

In an embodiment test statistics relevant to the user-selected product version components to be reviewed are provided to the user 940. In an aspect of this embodiment test statistics 165 output to a user 150 include the number of screenshots for the user-identified product version 430; the number of product version screenshots already reviewed 432; the product version review progress 434; the number of test cases for the user-identified product version 436; the number of test cases already run on the product version 438; and, the test result progress 440, as previously described with reference to FIG. 4. In other aspects of this embodiment more, less and/or different test statistics can be output to a user 150.

In an aspect of this embodiment the test statistics output to a user 940 are previously generated statistics 165 that are stored in one or more ITP databases 145 and/or are accessible to the ITP 110.

In an embodiment an initial, first, ITP review screen view is determined via user input 942. For example, in an embodiment a user 150 can choose to initially view all the screens 135 for a product version 115 by, e.g., selecting the all button 452 on the embodiment review initiation ITP screen 400 of FIG. 4. In this example an ITP pivot view screen 140 is generated and output to the user 150.

In an embodiment second example a user 150 can choose to initially view only those screens 135 for a product version 115 that have been previously reviewed by, e.g., selecting the reviewed button 454 on the embodiment review initiation ITP screen 400 of FIG. 4. In this second example an ITP screen 140 will all prior reviewed screens 135 for the user-selected product version 115 is generated and output to the user 150.

In an embodiment the generated initial ITP review screen is output to the user 944.

In an embodiment at decision block 946 a determination is made as to whether the user is requesting a new ITP review screen view, e.g., a new ITP screen 140 with a different set of one or more product version screens 135 displayed therein. If yes, in an embodiment the new ITP review screen view is determined via user input 948 and the subsequently generated ITP screen is output to the user 944. In an aspect of this embodiment the user 150 can identify different ITP review screen component(s), e.g., product version screens 135, to include in a new ITP review screen 140 by clicking on one or more product version screens 135 displayed in the current ITP review screen 140. In an aspect of this embodiment a user 150 can identify a different ITP review screen view utilizing relevant controls, e.g., buttons, pull-down menus, etc., on one or more ITP screens 140.

If at decision block 946 the user is not requesting a new ITP review screen view then in an embodiment, and referring to FIG. 9D, at decision block 954 a determination is made as to whether the user has identified an error in a product version, e.g., product version screen 135. In an embodiment a user 150 can identify an error in a product version screen 135 by selecting, e.g., clicking on, the erroneous product version screen component displayed in an ITP review screen 140.

If the user has identified an error then in an embodiment an ITP screen is generated that designates the identified error and the ITP screen is output to the user 958. For example, exemplary product version screen 605 of FIG. 6, with three errors indicated thereon, can be displayed within an ITP screen 140 to a user 150 upon the user 150 identifying the three errors.

In an embodiment the ITP automatically analyzes user identified product version screen errors and generates relevant information there from 960. Exemplary generated information can include, but is not limited to, a classification of the identified error; an identification of other product version screens 135 that may have the same type of error; an identification of other product versions 115 with screens 135 that may have similar errors; etc.

In an embodiment the ITP can automatically generate a bug report, or a portion of a bug report, for the identified error 962. In an embodiment the automatically generated bug report, or partial bug report, is stored for future use 964. In an aspect of this embodiment the automatically generated bug report 160, or partial bug report 160, is stored in an ITP database 145.

In an embodiment the ITP automatically transmits a generated bug report to one or more relevant parties 966, e.g., to the current user, to the group that coded the product version screen with the identified error, to the product development supervisor, etc.

In an embodiment the ITP automatically tags the product version screen with the currently identified error as failed 968; i.e., the ITP provides some indication that the relevant product version screen has not passed review.

In an embodiment the ITP automatically generates and stores statistics regarding the currently identified error 970. Exemplary statistics include an identification of the test case 125 run that generated the product version screen 135 with the current error; the date of the test case 125 execution; an identification of the current user 150; an identification of relevant individuals and/or groups that may be interested in the identified error; etc. In an aspect of this embodiment generated statistics are stored as bug report 160 meta data and/or product version screen 135 meta data. In an aspect of this embodiment generated statistics are stored in an ITP database(s) 145.

In an embodiment at decision block 972 a determination is made as to whether the use wants to generate a bug report for the current error. In aspects of this embodiment the user 150 may wish to generate a bug report that augments the bug report automatically generated by the ITP 110 or, alternatively, the ITP 110 may not have generated a bug report for the current error.

If at decision block 972 the user does not want to generate a bug report then in an embodiment the ITP can automatically suggest other review view(s) to the user, based on the currently identified error and the analysis thereof 974. For example, the ITP 110 can suggest an ITP review view that includes other product version screens 135 that the ITP 110 has identified as containing similar content to the product version screen component that was found to be in error and which may therefore contain similar errors.

In an embodiment control returns to decision block 946 of FIG. 9C, where a determination is made as to whether the user wants a new ITP review view.

If at decision block 972 the user wants to generate a bug report then in an embodiment, and referring to FIG. 9E, the ITP outputs an ITP screen with a bug report template to the user 980. An embodiment exemplary bug report template 800 is depicted in FIG. 8.

In an embodiment the ITP generates a bug report with user input 982. In an embodiment the ITP can also populate fields and/or bug report meta data automatically 982. In an embodiment the ITP stores the generated bug report 984. In an aspect of this embodiment the ITP 110 stores the generated bug report 160 in an ITP database 145.

In an embodiment the ITP automatically transmits a generated bug report to one or more relevant parties 986, e.g., to the group that coded the product version screen with the identified error, to the product development supervisor, etc.

In an embodiment the ITP automatically tags the product version screen with the currently identified error as failed 988; i.e., the ITP provides some indication that the relevant product version screen has not passed review.

In an embodiment the ITP automatically generates and stores statistics regarding the currently identified error 990. Exemplary statistics can include an identification of the test case 125 run that generated the product version screen 135 with the current error; the date of the test case 125 execution; an identification of the current user 150; an identification of relevant individuals and/or groups that may be interested in the identified error; etc. In an aspect of this

In an embodiment the ITP can automatically suggest other review view(s) to the user, based on the currently identified error and the analysis thereof 992. For example, the ITP 110 can suggest an ITP review view that includes other product version screens 135 that the ITP 110 has identified as containing similar content to the product version screen component that was found to be in error and which may therefore contain similar errors.

In an embodiment control returns to decision block 946 of FIG. 9C, where a determination is made as to whether the user wants a new ITP review view.

Returning to FIG. 9D, if at decision block 954 the user has not identified an error in a product version screen then in an embodiment at decision block 956 a determination is made as to whether the user wants to generate a bug report. If yes, referring again to FIG. 9E, in an embodiment the ITP outputs an ITP screen with a bug report template to the user 980 and generates a bug report with user input 982.

If at decision block 956 of FIG. 9D the user does not want to generate a bug report then, referring to FIG. 9E, in an embodiment at decision block 994 a determination is made as to whether the user has identified one or more product version screens as passing, i.e., have no errors, 994. If yes, in an embodiment the ITP tags the relevant product version screen(s) as passed 996; i.e., the ITP provides some indication that the relevant product version screen(s) has passed review.

In an embodiment the ITP automatically generates and stores statistics regarding the currently identified passed product version screen(s) 998. Exemplary statistics can include an identification of the test case 125 run that generated the product version screen(s) 135; the date of the test case 125 execution; an identification of the current user 150; the percentage of screens 135 for the product version 115 that have passed review; etc. In an aspect of this embodiment generated statistics are stored as product version screen 135 meta data. In an aspect of this embodiment generated statistics are stored in an ITP database(s) 145.

In an embodiment control returns to decision block 934 of FIG. 9C, where a determination is made as to whether the user wants to review product components, e.g., generated product version screens.

If at decision block 994 the user has not identified any product version screens as passing then in an embodiment control returns to decision block 934 of FIG. 9C where a determination is made as to whether the user wants to review product components.

### Computing Device Configuration

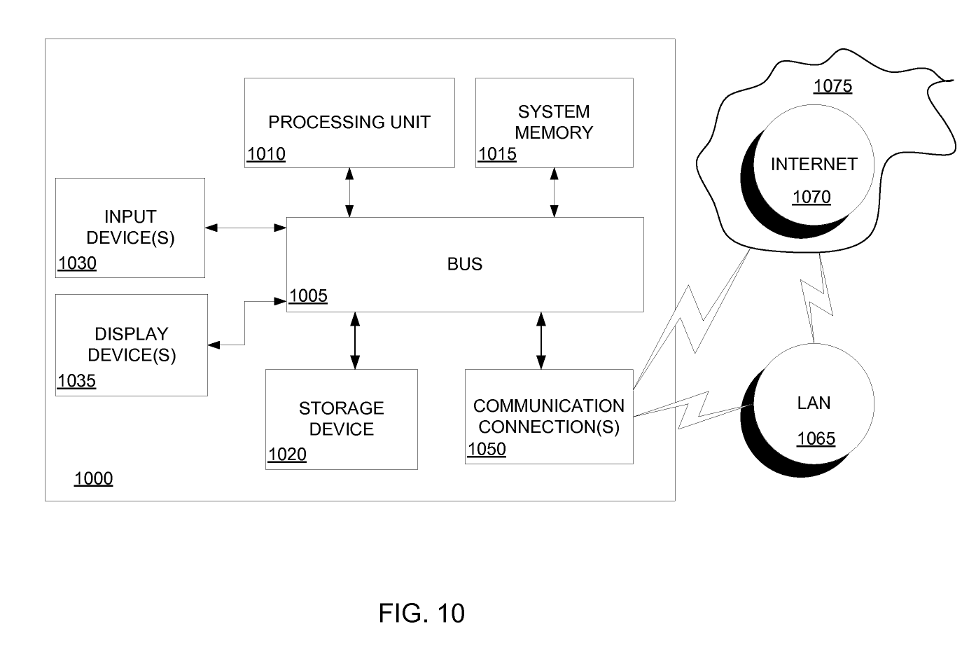

FIG. 10 is a block diagram that illustrates an exemplary computing device 1000 upon which an embodiment can be implemented. Examples of computing devices 1000 include, but are not limited to, computers, e.g., mainframe computers, desktop computers, computer laptops, also referred to herein as laptops, notebooks, netbooks, mobile devices with computational capability, etc.

The embodiment computing device 1000 includes a bus 1005 or other mechanism for communicating information, and a processing unit 1010, also referred to herein as a processor 1010, coupled with the bus 1005 for processing information. The computing device 1000 also includes system memory 1015, which may be volatile or dynamic, such as random access memory (RAM), non-volatile or static, such as read-only memory (ROM) or flash memory, or some combination of the two. The system memory 1015 is coupled to the bus 1005 for storing information and instructions to be executed by the processor 1010, and may also be used for storing temporary variables or other intermediate information during the execution of instructions by the processor 1010. The system memory 1015 often contains an operating system and one or more programs, or applications, and/or software code, and may also include program data.

In an embodiment a storage device 1020, such as a magnetic or optical disk, is also coupled to the bus 1005 for storing information, including program code of instructions and/or data. In an embodiment computing device 1000 the storage device 1020 is computer readable storage, or machine readable storage.

Embodiment computing devices 1000 generally include one or more display devices 1035, such as, but not limited to, a display screen, e.g., a cathode ray tube (CRT) or liquid crystal display (LCD), a printer, and one or more speakers, for providing information to a computing device user 150. Embodiment computing devices 1000 also generally include one or more input devices 1030, such as, but not limited to, a keyboard, mouse, trackball, pen, voice input device(s), and touch input devices, which a user 150 can utilize to communicate information and command selections to the processor 1010. All of these devices are known in the art and need not be discussed at length here.

The processor 1010 executes one or more sequences of one or more programs, or applications, and/or software code instructions contained in the system memory 1015. These instructions may be read into the system memory 1015 from another computing device-readable medium, including, but not limited to, the storage device 1020. In alternative embodiments, hard-wired circuitry may be used in place of or in combination with software instructions. Embodiment computing device 1000 environments are not limited to any specific combination of hardware circuitry and/or software.

The term “computing device-readable medium” as used herein refers to any medium that can participate in providing program, or application, and/or software instructions to the processor 1010 for execution. Such a medium may take many forms, including but not limited to, storage media and transmission media. Examples of storage media include, but are not limited to, RAM, ROM, EEPROM, flash memory, CD-ROM, digital versatile disks (DVD), magnetic cassettes, magnetic tape, magnetic disk storage, or any other magnetic medium, floppy disks, flexible disks, punch cards, paper tape, or any other physical medium with patterns of holes, memory chip, or cartridge. The system memory 1015 and storage device 1020 of embodiment computing devices 1000 are further examples of storage media. Examples of transmission media include, but are not limited to, wired media such as coaxial cable(s), copper wire and optical fiber, and wireless media such as optic signals, acoustic signals, RF signals and infrared signals.

An embodiment computing device 1000 also includes one or more communication connections 1050 coupled to the bus 1005. Embodiment communication connection(s) 1050 provide a two-way data communication coupling from the computing device 1000 to other computing devices on a local area network (LAN) 1065 and/or wide area network (WAN), including the world wide web, or internet 1070 and various other communication networks 1075, e.g., SMS-based networks, telephone system networks, etc. Examples of the communication connection(s) 1050 include, but are not limited to, an integrated services digital network (ISDN) card, modem, LAN card, and any device capable of sending and receiving electrical, electromagnetic, optical, acoustic, RF or infrared signals.

Communications received by an embodiment computing device 1000 can include program, or application, and/or software instructions and data. Instructions received by the embodiment computing device 1000 may be executed by the processor 1010 as they are received, and/or stored in the storage device 1020 or other non-volatile storage for later execution.

### Conclusion

While various embodiments are described herein, these embodiments have been presented by way of example only and are not intended to limit the scope of the claimed subject matter. Many variations are possible which remain within the scope of the following claims. Such variations are clear after inspection of the specification, drawings and claims herein. Accordingly, the breadth and scope of the claimed subject matter is not to be restricted except as defined with the following claims and their equivalents.

What is claimed is:

1. An international test platform and environment that supports centralized product review, the international testing platform and environment comprising:
a software product comprising at least one software product version;
a database that can store generated product version output components;
ITP screen generation software comprising the capability to generate ITP screens to be output to a user of the international test platform wherein at least one ITP screen can be utilized by a user to review at least one product version output component; and
ITP bug handler software comprising the capability to assist a user to generate a bug report for at least one error discovered in a software product version upon review.

2. The international test platform and environment of claim 1, wherein the international test platform supports product locality validation, wherein product version output components comprise product version screens, wherein the international test platform supports a user review of product version screens, wherein a user can review a first product version screen and indicate that the first product version screen is correct, and wherein a user can review a second product version screen to identify an error within the second product version screen.

3. The international test platform and environment of claim 2, wherein the international test platform comprises:
ITP bug handler software comprising the capability to automatically generate at least a portion of a bug report for an error discovered in a software product version; and,
ITP reporter software comprising the capability to generate a report comprising at least one product version review statistic wherein product version review statistics comprise the percentage of product version screens that have been reviewed, the percentage of product version screens that have at least one error, and the percentage of product version screens that have no errors.

4. The international test platform and environment of claim 3, wherein the international test platform comprises ITP reporter software comprising the capability to automatically output a generated report comprising at least one product version review statistic to at least one target audience comprising at least one individual.

5. The international test platform and environment of claim 2, wherein the ITP screen generation software comprises the capability to generate and output to a user an ITP screen comprising all the product version screens for a product version.

6. The international test platform and environment of claim 2, wherein the software product comprises at least two software product versions wherein each software product version is a different language version, and wherein the ITP screen generation software comprises the capability to generate and output to a user an ITP screen comprising the same product version screen for at least two software product versions.

7. An international test platform that provides a product review environment for at least one software product, wherein the at least one software product comprises at least one software product version, the international test platform comprising:
a manager comprising the capability to manage the flow of information into the international test platform;
a scheduler comprising the capability to schedule the execution of a test case for a software product version, wherein the execution of a test case on a software product version generates at least one output component of the software product version;
a producer comprising the capability to generate consumable output comprising information that can be presented to a user for the user to utilize for software product review;
an analyzer comprising the capability to perform analysis on output components of software product versions;
a bug handler comprising the capability to collate error information for an output component of a software product version into a form comprising a bug report; and
a reporter comprising the capability to automatically report error information for a software product version to a target audience comprising at least one individual.

8. The international test platform of claim 7, wherein the manager comprises a manager user interface comprising the capability to receive product input wherein the product input comprises at least one test case for testing at least a portion of at least one software product version, and wherein the product input further comprises at least one design file comprising a description of at least one output component of at least one software product version.

9. The international test platform of claim 7, wherein the manager comprises a manager user interface comprising the capability to receive product input wherein the product input comprises at least one output component of at least one software product version wherein an output component of a software product version comprises a software product version screenshot.

10. The international test platform of claim 7, wherein the producer generates consumable output comprising software product version screens that are generated when a test case is executed for a software product version.

11. The international test platform of claim 10, wherein the producer generates a set of test statistics for a software product version, wherein test statistics for a software product version comprises the number of output components for the software product version, the percentage of output components for a software product version that have been reviewed, the percentage of output components for a software product version that have been reviewed that have passed a review, and the percentage of output components for a software product version that have been reviewed that have failed a review wherein an output component comprising an error that is identified during a review fails the review.

12. The international test platform of claim 11, wherein the international test platform supports product locality verification, and wherein the output components of a software product version comprise software product version screens.

13. The international test platform of claim 11, wherein the reporter comprises the capability to generate a report comprising a set of test statistics for a software product version comprising at least one test statistic for the software product version, and wherein the reporter further comprises the capability to automatically output the report to a target audience as an email.

14. The international test platform of claim 7, wherein the analyzer comprises the capability to cause at least one test set tool to execute and wherein a test set tool comprises the capability to analyze at least one element of at least one output component of a software product version.

15. The international test platform of claim 7, wherein the manager comprises the capability to receive user input comprising an identification of an error on an output component of a software product version wherein output components of a software product version comprise software product version screenshots, and wherein the international test platform comprises the capability to generate and output to a user a product version screenshot with an error identified by a user distinguished therein.

16. The international test platform of claim 7, wherein the bug handler comprises the capability to be invoked by a user of the international test platform and which comprises the capability to generate a bug report utilizing information provided by the user.

17. The international test platform of claim 16, wherein the bug handler comprises the capability to generate a bug report utilizing product output component information collected by the international test platform wherein product output component information comprises meta data, wherein product output component information comprises test results data and wherein product output component information comprises test tool analysis data.

18. The international test platform of claim 7, wherein the producer comprises the capability to generate at least two ITP screen views wherein a first ITP screen view is a pivot view comprising all of a product version output components wherein a product version output component comprises a product version screenshot, and wherein a second ITP screen view is a cross language view comprising the same product version screenshot for each product version of a software product.

19. A method for centralized product locality testing and review, the method comprising:
the capability to enable the execution of at least one test case for at least one version of a product comprising at least one product version upon a user request to execute a test case on a product version;
storing product version screens, wherein a product version screen is generated by the execution of a test case on a product version;
the capability to output a first review screen to a user wherein the first review screen comprises a product version screen;
the capability to output a second review screen to a user wherein the second review screen comprises all the product version screens that are stored for one version of a product;
the capability to output a third review screen to a user wherein the third review screen comprises a product version screen from at least two different versions of a product;
generating a bug report when requested by a user wherein a bug report comprises an identification of an error on a product version screen;
the capability to automatically identify at least one individual to transmit a generated bug report to;
the capability to automatically transmit a generated bug report to at least one individual; and
generating a fourth review screen that comprises a product version screen with an identification of an error on the product version screen subsequent to the error being discovered.

20. The method for centralized product locality testing and review of claim 19, further comprising the capability to analyze an error on a product version screen and automatically provide an identification of at least one other product version screen that has been determined by the analysis to have a likelihood of an error.
